(19) United States
(12) Patent Application Publication
(10) Pub. No.: US 2016/0155347 A1
(43) Pub. Date: Jun. 2, 2016

(54) DEVICES, SYSTEMS AND METHODS OF ASSESSING THE FOUNDATIONS FOR THE HEALTHY DEVELOPMENT OF AN INFANT OR A YOUNG CHILD

(71) Applicant: NESTEC S.A., Vevey (CH)

(72) Inventors: Evelyn Spivey-Krobath, Savigny (CH); Vineet Singh, St-Legier (CH); Joanna Marie Soberano, Vevey (CH)

(21) Appl. No.: 14/952,969

(22) Filed: Nov. 26, 2015

Related U.S. Application Data
(60) Provisional application No. 62/085,260, filed on Nov. 27, 2014.

(51) Int. Cl. G09B 7/06; G09B 19/00; G09B 5/02

(52) U.S. Cl. CPC G09B 7/06; G09B 5/02; G09B 19/0092

(57) ABSTRACT

Devices, systems and methods assess one or more of the risk of an allergy, immediate and/or later in life, for the infant or young child; the risk of an underdeveloped immune system, immediate and/or later in life, for the infant or young child, and/or the immediate risk of a not well-functioning digestive system for the infant or young child, preferably all of these. Optionally, the risk of obesity, immediate and/or later in life, can be additionally assessed. Thus a user such as a parent can evaluate the health characteristics of the infant or young child and receive recommendations, such as a suggestion to visit to a healthcare professional. A device including a processor can provide an interactive tool that requests information related to the one or more health risks and uses the information to assess the presence or absence of the health risks for the infant or young child.

### PRIORITY CLAIM

The present application claims priority to U.S. provisional Application No. 62/085,260, filed Nov. 27, 2014, the entire contents of which are incorporated herein by reference.

### BACKGROUND

The present disclosure generally relates to devices, systems and methods for assessing the foundation for healthy development later in life of an infant or a young child. More specifically, the present disclosure relates to an interactive tool, e.g. an interactive application, that can help a parent enhance their knowledge on the importance of protein for healthy growth and development of their baby and can expose the parent, via their health care professional, to an optimized protein solution.

Breast milk provides the adequate protein quality and quantity for optimal growth and development of an infant. Although mother's milk is recommended for all infants, in some cases breast feeding is inadequate or unsuccessful for medical reasons or the mother chooses not to breast feed. Nutritional compositions such as infant formulas have been developed for these situations. Nevertheless, many such nutritional compositions are available, and some may be more appropriate for the health development of the specific child than others, depending on the specific health characteristics of the child.

In this regard, body weight status of children less than two years of age has been demonstrated to track through the toddler years, and subsequently into adulthood. At present, approximately 10-20% of infants and toddlers in the United States are overweight, setting the stage for an increased risk of lifelong obesity and its associated chronic diseases and health care costs. Interventions to successfully reduce rates of overweight in this young population have not been given adequate attention. Moreover, quantitative feeding recommendations or national food and nutrition guidelines are unavailable for U.S. children who are cared for at home and less than two years of age.

Critical periods for establishing dietary intake patterns, eating habits, and food preferences begin in infancy, and these tendencies are likely set by age two when children generally adopt the eating practices of the family. Parental feeding behaviors, if not causative for weight status in young children, are strongly associated with body weight and healthy food choices throughout childhood. Current research suggests that interventions to adjust food composition or caloric intake and increase physical activity, especially after infancy, have relatively little impact, and have been insufficient to curtail the increased prevalence of overweight affecting young children. Efforts to prevent excess weight gain during the school age years offer an approach that is simply too late. Twenty percent of preschool age children are already overweight.

Interventions that begin at birth target multi-faceted aspects of the diet, such as promotion of breastfeeding, and provide education to parents directly targeting factors related to healthy growth and obesity prevention are emerging as recommended research areas. Current evidence on obesity prevention points to specific dietary and physical activity/inactivity behaviors but also calls for attention to parental feeding behaviors and awareness of appropriate responses to infant hunger and satiety cues that parents can adopt for their children to encourage a healthy growth and weight status. While helpful in the fight against childhood obesity, these tactics do not fully address many of the components that contribute to childhood obesity.

In addition, the prevalence of allergic diseases increased rapidly within the last decades. By now over a third of the worldwide population is afflicted, and thus allergy has been considered as the new epidemic of the industrialized countries. The reasons for the steady increase in allergic diseases are not yet fully understood. Genetic background of the host is a prominent factor. Environmental factors such as lifestyle, pollution, decreasing family size, and reduction of microbial stimulation of the immune system in early life stage as a consequence of an improved hygienic situation seem to play an important role also.

Allergic sensitization in childhood, especially in early childhood and especially to food allergens, is critical and of highest interest as development of an “allergic phenotype” or “atopy” has been shown to facilitate subsequent adverse reactions to other allergens. Hence allergies in childhood can be the first step of an allergic cascade leading to multiple allergies later in life, a situation commonly referred to as “The Atopic March.” Therefore, preventing onset or attenuating the severity of food hypersensitivity may be crucial for slowing down the “Atopic March.” In this context, the management of allergic episodes and moreover prevention of allergies are, in childhood and infancy, of the highest importance.

Furthermore, development of the immune system in infants is reflected in the enhancement of specific immune responses to harmful antigens and in the induction of tolerance toward non-harmful environmental antigens, such as food components and also the microbiota of the infant gut. The human immune system can be modulated easily during the first months after birth, when the immune system can be affected not only positively but, unfortunately, also negatively. Delayed or impaired maturation of the immune system early in life can result in one or more immunologically-mediated conditions later in life.

Still further, an infant's digestive tract is not fully functional and undergoes enormous changes as it develops the ability to produce enzymes to digest food and antibodies to protect itself. At least 6 months are typically needed for a baby's digestive system to work properly and cope well with solid food.

Today parents lack awareness of the importance of protein quality and quantity for the healthy development of their baby.

### SUMMARY

The present disclosure provides devices, systems and methods that assist parents in evaluating the four cornerstones of healthy development of their infant or young child—growth, immunity, digestion and allergy—and create awareness of the important role of protein for those cornerstones and therefore for healthy development. The present disclosure provides interactive tools, e.g. interactive applications, for use with an electronic device, such as a desktop computer, a laptop computer, a tablet or a smartphone, that prompt parents to consider critical characteristics regarding the health development of their infant or young child. Preferably the tool is not meant to diagnose but will invite parents to consult their health care provider for further information on optimized protein.

Accordingly, in an embodiment, the present disclosure provides a method comprising: accepting user input into an interactive tool provided by a device comprising a processor, the user input comprising information regarding health characteristics of an infant or young child; performing an analysis of the information provided by the user input, and the analysis is performed by the device providing the interactive tool; and displaying on the device an indication of whether the infant or young child has a health risk or does not have the health risk, the indication is based at least partially on the analysis of the information by the device, and the health risk is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof.

In an embodiment, the health risk is selected from the group consisting of (i) an immediate risk of an allergy for the infant or young child, (ii) a risk of an allergy later in life for the infant or young child (short, medium or long term risk), (iii) an immediate risk of an underdeveloped immune system for the infant or young child, (iv) a risk of an underdeveloped immune system later in life for the infant or young child (short, medium or long term risk), (v) an immediate risk of a not well-functioning digestive system (e.g. not a smooth digestion) for the infant or young child and (vi) any combinations thereof.

In an embodiment, the method comprises displaying a message on the device, and the message is based at least partially on the analysis of the information by the device and suggests a visit to a healthcare professional to learn more about optimized protein solutions. The healthcare professional can identify one or more types of nutritional compositions to discuss with the parents. The one or more types of nutritional compositions may be one or more types of infant formula or growing up milk.

In an embodiment, the information accepted by the device comprises a first portion related to growth of the infant or young child, a second portion related to allergy characteristics of the infant or young child, a third portion related to immunity characteristics of the infant or young child, and a fourth portion related to digestive characteristics of the infant or young child. The first, second, third and fourth portions can be accepted by the device sequentially relative to each other.

In an embodiment, the indication displayed by the device can identify how many of the health risks are applicable to the infant or young child.

In an embodiment, the analysis can further comprise determining a presence or absence of an immediate risk of obesity and/or a risk of obesity later in life, and the presence or absence can be at least partially based on a criterion selected from the group consisting of (i) whether the infant or young child is/was exclusively breastfed for the first 6 months after birth, (ii) a threshold pre-pregnancy body mass index (BMI) of the mother of the infant or young child, (iii) a threshold weight of the infant at birth, (iv) weight gain of the infant or young child since birth and (v) any combinations thereof.

The determining whether the infant or young child has an immediate risk of allergy and/or a risk of an allergy later in life can be at least partially based on a criterion selected from the group consisting of (i) whether the infant or young child is/was exclusively breastfed for the first 6 months after birth; (ii) whether one of the parents has an allergy history; (iii) whether any direct relatives have an allergy history; (iv) if the family lives in a polluted city; (v) whether the infant or young child lives in an environment with second-hand smoke or was the mother exposed to tobacco smoke during pregnancy; and (vi) any combinations thereof.

The determining whether the infant or young child has an immediate risk of an underdeveloped immune system and/or a risk of an underdeveloped immune system later in life can be at least partially based on a criterion selected from the group consisting of (i) whether the infant or young child is/was exclusively breastfed for the first 6 months after birth, (ii) whether the infant or young child suffers from recurrent ear infections, (iii) whether the infant or young child regularly catches colds, (iv) whether the infant or young child has been diagnosed with asthma or allergies, (v) whether the infant or young child lives in an environment with second hand smoke, and (vi) any combinations thereof.

The determining whether the infant or young child has an immediate risk of a not well functioning digestive system (e.g. not a smooth digestion) can be at least partially based on a criterion selected from the group consisting of (i) whether the infant or young child ever has unusually runny stools, (ii) whether the infant or young child ever had colic, and (iii) any combinations thereof.

The determining whether the infant or young child has an immediate risk of a not well functioning digestive system (e.g. not a smooth digestion) can be at least partially based on a criterion selected from the group consisting of (i) whether the infant or young child ever has unusually runny stools, (ii) whether the infant or young child ever had colic, (iii) whether the infant or young child has difficulty passing stools and/or has very hard stools, (iv) whether the infant or young child regularly spits up their feed, and (v) any combinations thereof.

In another embodiment, the present disclosure provides a device comprising a processor and configured to display data fields for entry of information related to a health risk selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof, and the processor is configured to evaluate a presence or absence of the health risk for the infant or young child based at least partially on the information.

In an embodiment, the health risk is selected from the group consisting of (i) an immediate risk of an allergy for the infant or young child, (ii) a risk of an allergy later in life for the infant or young child (short, medium or long term risk), (iii) an immediate risk of an underdeveloped immune system for the infant or young child, (iv) a risk of an underdeveloped immune system later in life for the infant or young child (short, medium or long term risk), (v) an immediate risk of a not well-functioning digestive system (e.g. not a smooth digestion) for the infant or young child and (vi) any combinations thereof.

In an embodiment, the device is configured to additionally display data fields for entry of information related to an immediate risk of obesity and/or a risk of obesity later in life.

In an embodiment, the device is selected from the group consisting of a tablet, a smartphone, a desktop computer, a laptop computer, and a personal digital assistant.

In an embodiment, the device comprises a component selected from the group consisting of: (i) means for determining whether or not the infant or young child has an immediate risk of an allergy, (ii) means for determining whether or not the infant or young child has a risk of an allergy later in life, (iii) means for determining whether or not the infant or young child has an immediate risk of an underdeveloped immune system, (iv) means for determining whether or not the infant or young child has a risk of an underdeveloped immune system later in life, (v) means for determining whether or not the infant or young child has an immediate risk of a not well-functioning digestive system, and (vi) any combinations thereof.

In an embodiment, the device additionally comprises means for determining whether or not the infant or young child has an immediate risk of obesity and/or means for determining whether or not the infant or young child has a risk of obesity later in life (short, medium or long term risk).

In another embodiment, the present disclosure provides a system comprising a database connected to a remotely located device comprising a processor providing an interactive tool that evaluates a health risk for an infant or young child, the health risk is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof, and the database updates the interactive tool with a factor for the health risk.

In an embodiment, the health risk is selected from the group consisting of (i) an immediate risk of an allergy for the infant or young child, (ii) a risk of an allergy later in life for the infant or young child (short, medium or long term risk), (iii) an immediate risk of an underdeveloped immune system for the infant or young child, (iv) a risk of an underdeveloped immune system later in life for the infant or young child (short, medium or long term risk), (v) an immediate risk of a not well-functioning digestive system (e.g. not a smooth digestion) for the infant or young child and (vi) any combinations thereof.

In an embodiment, the interactive tool can additionally evaluate an immediate risk of obesity and/or a risk of obesity later in life

In an embodiment, the device is configured to accept user input providing information relating to the health risk for a specific infant or young child, and the database stores at least a portion of the information.

In another embodiment, the present disclosure provides a method comprising: accepting input from a user into an interactive tool provided by a device comprising a processor, the user input comprising information related to one or more health risks for an infant or young child, each of the one or more health risks is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof; and displaying on the device a message based at least partially on the health risks that are applicable to the young child or infant, and the message invites the user to contact a health care professional for advice on optimized protein solutions (e.g. specific types of infant formula or growing up milk).

In an embodiment, the health risk is selected from the group consisting of (i) an immediate risk of an allergy for the infant or young child, (ii) a risk of an allergy later in life for the infant or young child (short, medium or long term risk), (iii) an immediate risk of an underdeveloped immune system for the infant or young child, (iv) a risk of an underdeveloped immune system later in life for the infant or young child (short, medium or long term risk), (v) an immediate risk of a not well-functioning digestive system (e.g. not a smooth digestion) for the infant or young child and (vi) any combinations thereof.

In an embodiment, the user input additionally comprises information related to an immediate risk of obesity and/or a risk of obesity later in life.

In an embodiment, the optimized protein solutions that might be recommended by the health care professional can be a nutritional composition or a set of nutritional compositions. The nutritional composition may have an adapted source of protein (e.g. casein, whey or a mixture thereof in specific ratios), proteins with an adapted extent of hydrolysis (also called degree of protein hydrolysis, e.g. the proteins could be intact, hydrolysed—fully or partially hydrolysed—or could be a mixture thereof), an adapted amount of protein, or any combinations thereof. Indeed HA proteins are known to be easier to digest and compositions with a too high protein amount will be more difficult to digest. In a particular embodiment, the nutritional composition may contain modified sweet whey (MSW) that may be obtained using the process described in WO98/53702 (fully incorporated by reference). For example, the optimized protein solution might be an infant formula such as Nan 1 from Nestlé, comprising 1.8 g protein/100 kcal, with MSW whey and a whey:casein ratio of 70/30. Another example of optimized protein solutions can be an infant formula such as Nan HA 1 from Nestlé, comprising 1.9 g protein/100 kcal, with 100% whey that is partially hydrolysed. The optimized protein solutions may also consist of a set of nutritional compositions, i.e. at least 2 types of infant formula and/or growing-up milks, e.g. at least 2 successive infant formulas of different type, or at least one type of infant formula followed by at least one type of growing-up milk.

An advantage of the present disclosure is to utilize an electronic device to achieve an improvement in another technical field—generally nutrition for an infant or young child and specifically protein optimization for an infant or young child.

Another advantage of the present disclosure is to raise awareness of a parent, such as a mother, about the importance of protein quality and quantity for the healthy development of their infant or young child.

Still another advantage of the present disclosure is to encourage prevention of obesity, immediately and/or later in life, for an infant or young child.

Yet another advantage of the present disclosure is to encourage prevention of allergy, immediately and/or later in life, for an infant or young child.

An additional advantage of the present disclosure is to encourage a properly developed immune system, immediately and/or later in life, for an infant or young child.

Another advantage of the present disclosure is to promote a properly developed digestive system immediately for an infant or young child.

Still another advantage of the present disclosure is to prompt a parent to consider the various cornerstones of child health development while the child is at a young age, for example an infant.

Yet another advantage of the present disclosure is to lead a parent to a health care professional who can identify appropriate action(s) for a parent to address a risk or a high risk of a health problem later in life of an infant or a young child.

An additional advantage of the present disclosure is an easily navigable interactive tool to evaluate the health development of an infant or a young child.

Another advantage of the present disclosure is to compile information that can help a pediatrician treating an infant or a young child, for example help the pediatrician make a nutritional recommendation such as adequate product solutions.

Still another advantage of the present disclosure is to provide educational information regarding the impact of current characteristics on immediate health risks and/or health risks later in life for an infant or a young child.

Yet another advantage of the present disclosure is providing graphics to assist understanding of the health development of an infant or a young child.

An additional advantage of the present disclosure is an online tool to evaluate the health development of an infant or a young child.

Still another advantage of the present disclosure is an interactive tool accessible over the internet that evaluates the health development of an infant or a young child.

An additional advantage of the present disclosure is to monitor and evaluate the critical health characteristics of an infant or young child for at least the first six months after birth.

Additional features and advantages are described in, and will be apparent from, the following Detailed Description and the Figures.

### BRIEF DESCRIPTION OF DRAWINGS

FIG. 1 illustrates an embodiment of an introductory screen of a user interface of a device providing an interactive tool according to the present disclosure.

FIGS. 2-4 illustrate embodiments of a growth assessment screen of a user interface of a device providing an interactive tool according to the present disclosure.

FIGS. 5-7 illustrate embodiments of an allergy assessment screen of a user interface of a device providing an interactive tool according to the present disclosure.

FIGS. 8-10 illustrate embodiments of an immunity assessment screen of a user interface of a device providing an interactive tool according to the present disclosure.

FIG. 11 illustrates an embodiment of a digestive assessment screen of a user interface of a device providing an interactive tool according to the present disclosure.

FIGS. 12-15 illustrate embodiments of a summary screen of a user interface of a device providing an interactive tool according to the present disclosure.

FIG. 16 illustrates an embodiment of a method provided by the present disclosure.

### DETAILED DESCRIPTION

All percentages and ratios are by weight unless otherwise specified.

The term “database” means the hardware (e.g., a computer) and/or the software (e.g., a computer program such as a computer application) that receives, stores, processes and delivers content that can be accessed, for example, through the internet using a website hosted by the database and/or a web server associated with the database.

The term “automatically” means without user input being necessary. An operation performed “automatically” can comprise one or more actions by the corresponding device, but each of the actions is performed without a requirement of user input.

The term “sequentially” means that information is input or displayed in a successive manner such that a first portion of the information is input or displayed at a first time, a second portion of the information is input or displayed at a second time subsequent to the first time, and so on. The time between sequential inputs or displays may be, for example, one or several seconds, minutes, hours, days, weeks, months, or the like.

The devices, systems and methods according to the present invention can be applied to infants and/or young children. The term “infant” means a child under the age of 12 months. The infants are preferably term infants. The expression “young child” means a child aged between one and three years, also called toddler.

The expression “nutritional composition” means a composition which provides at least one nutrient to a subject. A nutritional composition is usually administered orally or intravenously usually. It includes a protein source, a lipid or fat source and/or a carbohydrate source. In the present invention, the nutritional composition preferably includes at least a protein source. Some examples are infant formula, growing-up milks, supplements, and the like. Nutritional compositions can be in powder or liquid forms. In some particular embodiments, the nutritional composition may be a hypoallergenic nutritional composition, i.e. a nutritional composition which is unlikely to cause allergic reactions. The protein of the nutritional composition may be intact, hydrolysed (partially or fully) or it can be a mixture thereof. The term “hydrolysed” means a protein which has been hydrolysed or broken down into its component amino acids. The proteins may be either fully or partially hydrolysed. It may be desirable to supply partially hydrolysed proteins (e.g. with a degree of hydrolysis between 2 and 20%), for example for infants or children believed to be at risk of developing cow's milk allergy. If hydrolysed proteins are required, the hydrolysis process may be carried out as desired and as is known in the art. The degree of hydrolysis (DH) of the protein can be between 2 and 20, or between 8 and 40, or between 20 and 60 or between 20 and 80 or more than 10, 20, 40, 60, 80 or 90. For example, nutritional compositions containing hydrolysates having a degree of hydrolysis less than about 15% are commercially available from Nestle Company under the trade mark Peptamen®. Hydrolysates having a degree of hydrolysis above about 15% may be prepared using the procedure described in EP 0322589.

The expression “infant formula” means a foodstuff intended for particular nutritional use by infants during the first months after birth and satisfying by itself the nutritional requirements of this category of person (Article 2(c) of the European Commission Directive 91/321/EEC 2006/141/EC of 22 Dec. 2006 on infant formulae and follow-on formulae). Generally a starter formula is administered to infants starting at birth as breast-milk substitute, and a follow-up or follow-on formula is given from the 6^{th} month onward. “Growing-up milks” (or GUMs) are administered to a child from one year of age onward. The expression “growing-up milk” means a milk-based beverage adapted for the specific nutritional needs of young children.

The term “later in life” refers to effects measured in the child after the age of 1 year after birth, such as after the age of 2 years, preferably after the age of 4 years, more preferably after the age of 5 years, even more preferably after the age of 7 years after birth and as a comparison to average observations for subjects of the same age. So the term “later in life” might refer to an observation during childhood, during the adolescent period, or during adulthood. Further in this regard, “later in life” includes one or more of short, medium and long term risk.

The term “immediate risk” refers to a risk that appears without delay and disappears as soon as the cause disappears because the risk is closely/directly linked to the cause.

Body mass index (“BMI”) is defined as the value resulting from division of a numerator that is the weight in kilograms by a denominator that is the height in meters, squared. Alternatively, the BMI can be calculated from the weight in pounds as the numerator and the height in inches, squared, as the denominator, with the resultant quotient multiplied by 703. “Overweight” is defined for a human as a BMI between 25 and 30. “Obese” is defined for a human as a BMI greater than 30.

“Risk factors” are parameters and/or elements that allow evaluating the risk of one or more of: (i) a risk of an allergy for the infant or young child, (ii) a risk of an underdeveloped immune system for the infant or young child, (iii) a risk of a not well-functioning digestive system for the infant or young child and (iv) any combinations thereof. For example, risk factors can be parameters and/or elements that allow evaluating the risk of one or more of: (i) an immediate risk of an allergy for an infant or young child, (ii) a risk of an allergy later in life for an infant or young child (short, medium or long term risk), (iii) an immediate risk of an underdeveloped immune system for an infant or young child, (iv) a risk of an underdeveloped immune system later in life for an infant or young child (short, medium or long term risk), (v) an immediate risk of a not well-functioning digestive system (e.g. not a smooth digestion) for an infant or young child and (vi) any combinations thereof. The more risk factors that are present for the infant or young child, the higher will be the risk for the infant or young child to develop health problems later in life. In some embodiments, “risk factors” further comprise parameters and/or elements that allow evaluating the risk of obesity for the infant or young child, e.g., an immediate risk of obesity and/or a risk of obesity later in life for an infant or young child (short, medium or long term risk).

In addition, when mentioning the expression at the risk of obesity, an allergy, or an underdeveloped immune system later in life, it should be understood as at the risk of developing or having such health conditions later in life. Moreover, the term “underdeveloped” in the expression “underdeveloped immune system” means that the immune system will be less strong (e.g. a lower amount of immune defensive agents) as a comparison to average observations for subjects of the same age. The expression “not well functioning” in the expression “not well functioning digestion system” means that the stool is of bad quality (e.g. running stool) and/or there may be gastro-intestinal symptoms such as colic, constipation, and the like.

The expression “weight gain” corresponds to the “weight-for-length gain” or “weight-for-length increase” over a certain period. It may be illustrated by a weight-for-length curve, also called growth curve or weight gain curve. These expressions can be used interchangeably.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a measuring device” or “a method” includes a plurality of such “measuring devices” or “methods.” For example, “a risk of an allergy later in life” means a risk of at least one allergy later in life, and therefore there may be several allergies (i.e. a risk of allergies later in life). Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of” and “consisting of” the disclosed components. Where used herein, the term “examples,” particularly when followed by a listing of terms, is merely exemplary and illustrative, and should not be deemed to be exclusive or comprehensive.

It is noted that the various aspects, features, examples and embodiments of the devices, systems and methods described in the present disclosure may be compatible and/or combined together, unless otherwise specified.

The present disclosure is generally directed to devices, systems and methods for assessing the foundation for healthy development of an infant or a young child. For example, a program executed by a device comprising a processor can provide an interactive tool that requests information related to health characteristics of an infant or young child and provides educational information regarding the health development of an infant or young child.

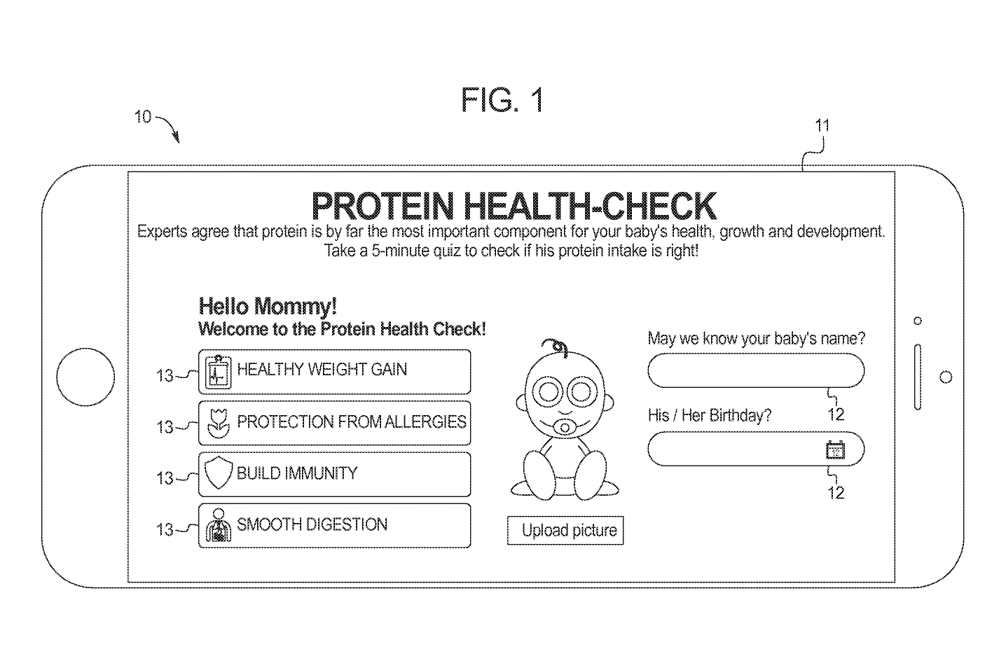

For example, as generally shown in FIG. 1, the program (e.g. an application) can be executed by a device 10 of a user, preferably a parent such as a mother of an infant or young child. The device 10 can be a stationary and/or mobile communications device, for example at least one of a mobile telephone, such as a smartphone; a laptop computer; a desktop personal computer; a tablet; or a personal digital assistant. The program can be executed and/or stored by the device 10. The program can be obtained by the device 10 using wired and/or wireless networks, for example the internet, telephone lines, WiFi/WLAN, 3G networks, or the like.

The device 10 can store the program in a non-transitory computer readable storage medium that is any computer-readable media except for a transitory, propagating signal. Non-limiting examples of computer-readable media that can store the program include any type of disk including optical disks, CD-ROMs, and magnetic-optical disks; read-only memories (ROMs); random access memories (RAMs); EPROMs; EEPROMs; magnetic or optical cards; program specific integrated circuits (ASICs); and any type of media suitable for storing electronic instructions.

The program can be obtained and/or can be accessed by selection of a corresponding icon using the device 10. The icon can visually indicate the identity of the program, such as by depicting a representation of an infant. In an embodiment, the program can be obtained from an application store for the corresponding type of device 10 or operating system of the device 10. In an embodiment, the program can be accessed using a web browser and the internet.

The device 10 providing the interactive tool can provide a user interface that can display one or more introductory screens 11 (hereafter “the introductory screen 11”). The introductory screen 11 can comprise data fields 12 in which the user can enter identifying information regarding an infant or a young child, such as the name of the infant or young child and/or the birthday of the infant or young child. In a preferred embodiment, the interactive tool provided by the program uses the name to refer to the infant or young child in subsequent screens and/or uses the birthday and the current date to determine the age of the infant or young child. In an embodiment, the interactive tool enables the user to upload a photo of the infant or young child; for example, the introductory screen 11 can enable the user to upload a photo of the infant or young child.

The user can enter the information into the data fields 12 using any known input component of the device 10 providing the interactive tool, such as a keyboard, a touchscreen, a trackball, and the like, and the present disclosure is not limited to a specific embodiment of the input component of the device 10.

The introductory screen 11 can comprise a message, for example a message containing one or more of the following statements: actions of the parent now determine how healthy the infant or young child grows up; some factors in early infancy that influence development can be controlled, and other factors cannot; proteins are one of the most important nutrients that help build a strong foundation for healthy development; proteins are the main building block of the body and are necessary for human life; and/or the quality of proteins received in early life can affect weight gain, likelihood of developing allergies, immune system health and digestion.

The introductory screen 11 can comprise buttons 13 for tests provided by the interactive tool, for example a test related to growth, a test related to immunity, a test related to digestion and a test related to allergy. The device 10 can accept user input selecting one of the buttons 13, and as detailed hereafter the device 10 providing the interactive tool can provide the corresponding test in a screen displayed by the user interface.

Each of the tests is preferably arranged to comprise: (i) a description of why the corresponding area (e.g., growth, immunity, digestion and allergy) has an impact on the health later in life for the infant or young child and/or the relevance of protein to the corresponding area; (ii) one or more inquiries requesting user input regarding characteristics of the infant or young child with respect to the corresponding area; and (iii) an outcome of the test, such as information about the role of protein in the corresponding area, an invitation to take the other tests, and recommendations such as a visit to a doctor or a suggested educational website. These displayed items can be provided on one screen or across a plurality of screens. In a preferred embodiment, each of the tests includes an inquiry whether the infant or young child is/was exclusively breastfed for the first 6 months after birth, most preferably as the first inquiry of each test. Each of the tests can include additional features not disclosed or depicted herein and may lack one or more of the features disclosed or depicted herein.

Subsequent figures do not show the device 10, but it is to be understood that all of the screens disclosed herein are displayed on the device 10. Furthermore, the screens may be displayed by the device 10 providing the interactive tool in any order, and the present disclosure is not limited to the order of screens depicted in the figures and discussed in the text. Moreover, the screens displayed by the device 10 providing the interactive tool may include additional screens not disclosed herein and may lack one or more of the screens disclosed herein.

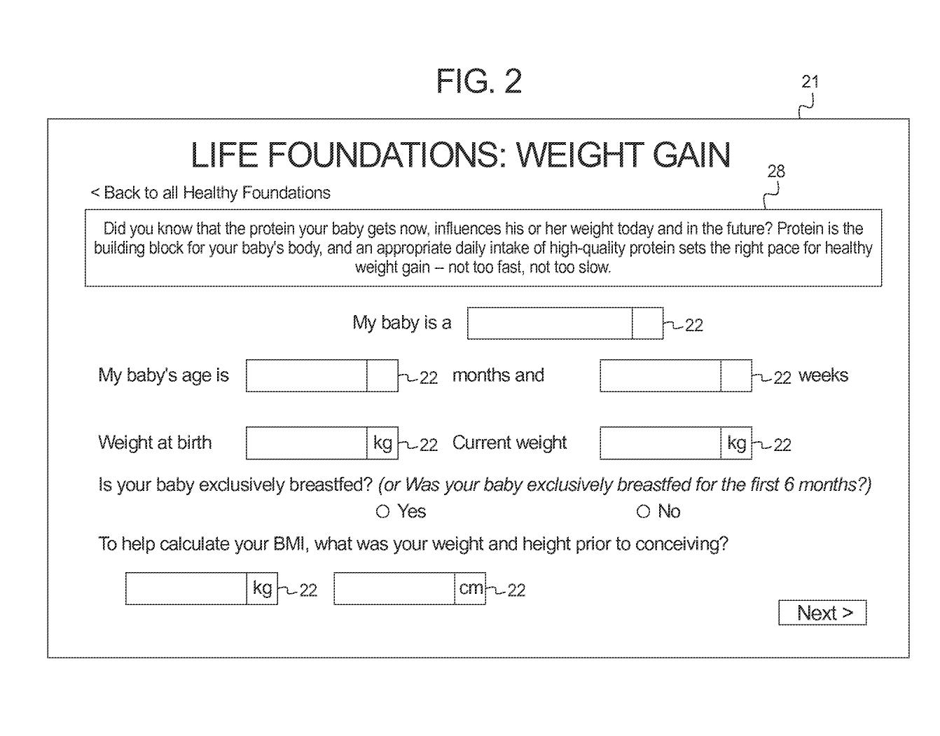

As shown in FIGS. 2-4, the device 10 providing the interactive tool can provide one or more growth assessment screens 21 (hereafter “the growth assessment screen 21”) in the user interface, for example in response to user input selecting a corresponding button from the buttons 13. Each of the screens can include additional features not disclosed or depicted herein and may lack one or more of the features disclosed or depicted herein.

The growth assessment screen 21 can provide data fields 22 in which the user can enter information regarding the growth of the infant or young child. Non-limiting examples of such information include whether the infant or young child is/was exclusively breastfed for the first 6 months after birth, the gender of the infant or young child, the age of the infant or young child, the weight and height at birth of the infant or young child, whether the baby is following his or her growth curve or not, and the height and weight of the mother before conception. The height and weight of the mother before conception can be used to determine the BMI of the mother before conception and thus whether the mother was overweight or obese before conception. The age of the infant or young child is preferably auto-filled based on the birthday entered into the introductory screen 11.

A growth curve is a weight-for-length curve, also called a weight gain curve. A rapid weight gain, also named a rapid weight-for-length gain, a rapid weight percentile increase, or a rapid weight-for-length percentile increase, occurs for example when the growth curve of the infant crosses at least one major percentile on the World Health Organization (WHO) Growth Curve during the first two years of age. In an embodiment, the growth assessment screen 21 can display the WHO Growth Curve for male babies and/or the WHO Growth Curve for female babies.

The growth assessment screen 21 can display information icons 23 adjacent the data fields 22. A user can select one of the information icons 23 to obtain further information related to the inquiry associated with the one of the data fields 22 corresponding to the selected information icon 23. For example, the further information can indicate why the corresponding inquiry is relevant to the health of the infant or young child. In an embodiment, the WHO Growth Curves are displayed in response to selection of one of the information icons 23 that is adjacent the inquiry whether the baby is following his or her growth curve or not. The further information can be displayed on the same screen as the data fields 22, for example as a pop-up box, or can be displayed on a different screen.

The growth assessment screen 21 can display a screen description 28 that can indicate why growth of the infant or young child has an impact on the immediate health and/or the health later in life for the infant or young child. Additionally or alternatively, the screen description 28 can indicate the relevance of protein to the growth of the infant or young child. For example, the screen description 28 can comprise a message that protein influences weight both now and in the future for the infant or young child, and appropriate daily protein intake influences the weight gain of the infant or young child and can make the weight gain optimal. As another example, the screen description 28 can comprise a message that indicates that the weight gain of the infant or young child should not cross a major percentile of the WHO Growth Curve for the gender of the infant or young child.

The user can enter the information into the data fields 22 using any known input component of the device 10 providing the interactive tool, such as a keyboard, a touchscreen, a trackball, and the like, and the present disclosure is not limited to a specific embodiment of the input component of the device 10.

The device 10 providing the interactive tool can perform an analysis of the information entered into the data fields 22 of the growth assessment screen 21. For example, the growth assessment screen 21 can comprise a button, and selection of this button can prompt the device 10 providing the interactive tool to analyze the information. The interactive tool may have criteria by which the information is analyzed and/or with which the information is compared. For example, the criteria can specify the presence or absence of factors for health development. As another example, the criteria can comprise one or more thresholds for comparison with the information entered into the data fields 22 and/or for comparison with values derived from the information entered into the data fields 22.

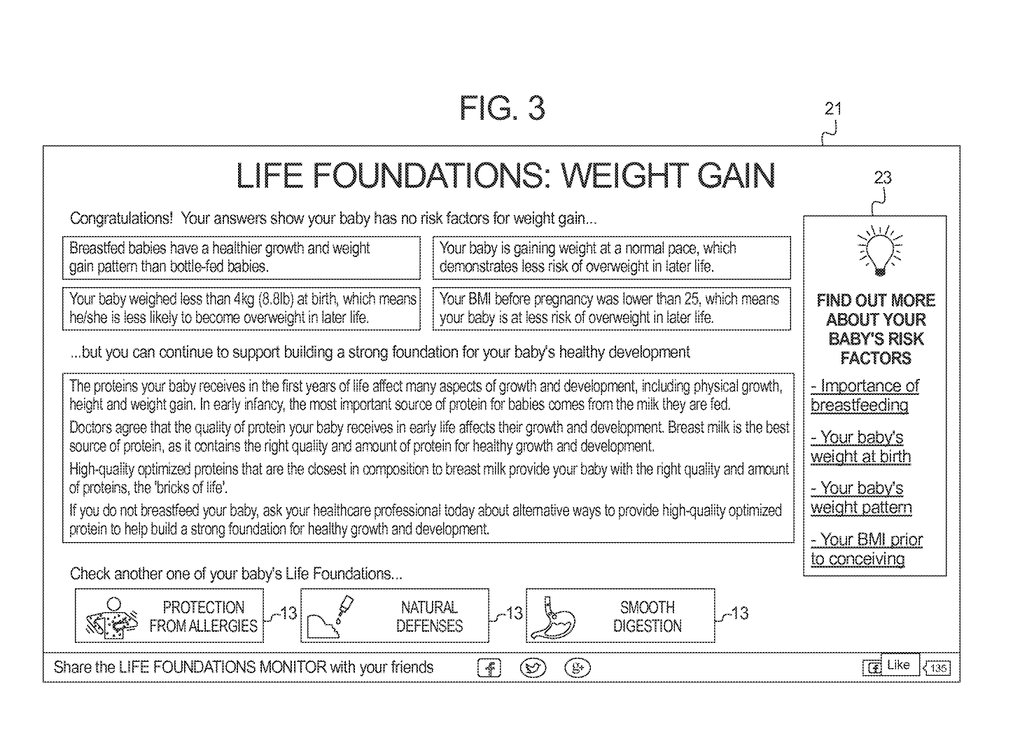

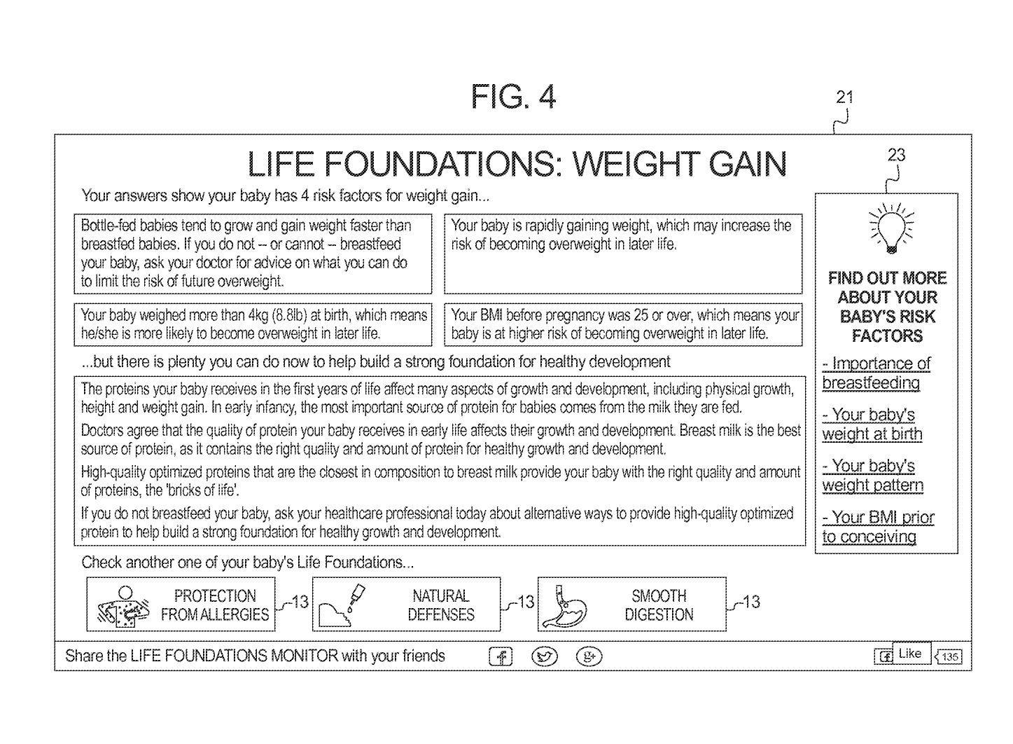

In a preferred embodiment, the device 10 providing the interactive tool can determine if the infant or young child has an immediate risk of obesity and/or a risk of obesity later in life and display the determination in the user interface, for example in the growth assessment screen 21 (FIGS. 3 and 4), such as by updating the growth assessment screen 21 or providing a completely new version of the growth assessment screen 21. The device 10 providing the interactive tool can use the information entered into the data fields 22 to determine if the infant or young child has an immediate risk of obesity and/or a risk of obesity later in life.

The information entered into the user interface can be analyzed as sub-factors for the immediate risk of obesity and/or the risk of obesity later in life, preferably using an algorithm. As an example of part of the analysis in this determination, the device 10 providing the interactive tool can determine the BMI of the mother before pregnancy and compare this value to a threshold, such as 25 kg/m² for example. If the BMI of the mother exceeds the corresponding threshold, the device 10 providing the interactive tool can specify that this sub-factor is present. If the BMI of the mother falls below the corresponding threshold, the device 10 providing the interactive tool can specify that this sub-factor is absent.

As another example of part of the analysis in determination of whether the infant or young child has an immediate risk of obesity and/or a risk of obesity later in life, the device 10 providing the interactive tool can compare the birth weight of the infant to a threshold, such as 4 kg for example. If the birth weight of the infant exceeds the corresponding threshold, the device 10 providing the interactive tool can specify that this sub-factor is present. If the birth weight of the infant falls below the corresponding threshold, the device 10 providing the interactive tool can specify that this sub-factor is absent.

As yet another example of part of the analysis in determination of whether the infant or young child has an immediate risk of obesity and/or a risk of obesity later in life, the device 10 providing the interactive tool can identify whether the infant or young child is/was exclusively breastfed for the first 6 months after birth or not. If the infant or young child is/was not exclusively breastfed for the first 6 months after birth, the device 10 providing the interactive tool can specify that this sub-factor is present. If the infant or young child is/was exclusively breastfed for the first 6 months after birth, the device 10 providing the interactive tool can specify that this sub-factor is absent.

As yet another example of part of the analysis in determination of whether the infant or young child has an immediate risk of obesity and/or a risk of obesity later in life, the device 10 providing the interactive tool can detect whether the infant or young child has a rapid weight gain. A rapid weight gain, also named a rapid weight-for-length gain, a rapid weight percentile increase or a rapid weight-for-length percentile increase, occurs for example when the growth curve (i.e. the weight-for-length evolution over time) of the infant crosses at least one major percentile on the World Health Organization Growth Curve during the first two years of age.

Accordingly, the device 10 providing the interactive tool can determine if the infant or young child has an immediate risk of obesity and/or a risk of obesity later in life using sub-factors determined by the information entered into the data fields 22 of the growth assessment screen 21. As shown in FIGS. 3 and 4, the device 10 can identify which of the obesity sub-factors are fulfilled and which of the obesity sub-factors are not fulfilled.

Preferably the user is initiating use of the interactive tool at a time proximate to the birth of the infant, in which case this sub-factor regarding whether the growth of the infant or young child is a risk factor, i.e. the weight percentile increase of the infant or young child, cannot be determined. However, after at least a portion of the growth curve is entered as discussed in more detail hereafter, the device 10 providing the interactive tool can consider the weight-for-length percentile increase and use it in determination of whether the growth of the infant or young child is a risk factor or not.

An embodiment of the interactive tool can indicate the progress of the user through the tests provided by the device 10 providing the interactive tool. For example, a portion of the screen, such as the top of the screen, can identify each of the tests and identify the specific test that the user is currently presented.

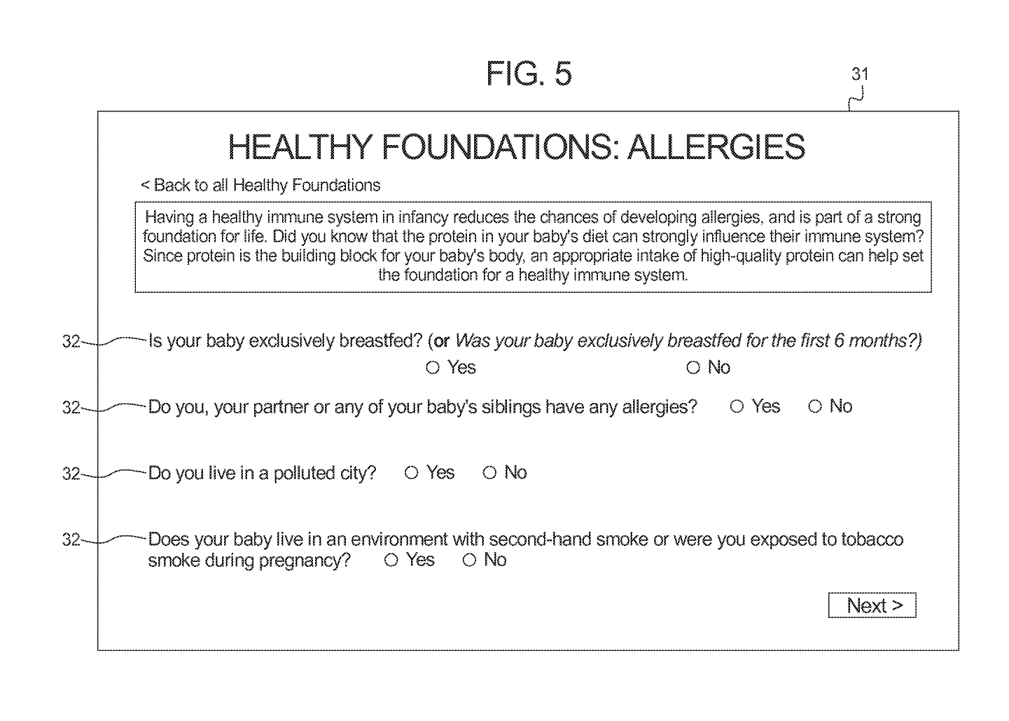

As shown in FIGS. 5-7, the device 10 providing the interactive tool can provide one or more allergy assessment screens 31 (hereafter “the allergy assessment screen 31”) in the user interface, for example in response to user input selecting a corresponding button from the buttons 13. The allergy assessment screen 31 can provide data fields 32 in which the user can enter information regarding the possibility of allergy in the infant or young child. Non-limiting examples of such information include whether the infant or young child is/was exclusively breastfed for the first 6 months after birth; whether one of the parents has an allergy history; whether any direct relatives have an allergy history; if the family lives in a polluted city; whether the infant or young child lives in an environment with second-hand smoke or was the mother exposed to tobacco smoke during pregnancy; and any combinations thereof.

The allergy assessment screen 31 can display information icons 33 adjacent the data fields 32. A user can select one of the information icons 33 to obtain further information related to the inquiry associated with the one of the data fields 32 corresponding to the selected information icon 33. For example, the further information can indicate why the corresponding inquiry is relevant to the health of the infant or young child. The further information can be displayed on the same screen as the data fields 32, for example as a pop-up box, or can be displayed on a different screen.

The allergy assessment screen 31 can display a screen description 38 that can explain allergies (e.g., allergies happen when your body's immune system reacts to a foreign substance that does not typically cause a reaction in most people; a rash, dry skin and itching are some of the symptoms that allergies may cause; and/or the proteins in the milk or food fed to the infant or young child may trigger an allergic reaction). The screen description 38 can indicate why the possibility of allergy in the infant or young child has an impact on the health later in life for the infant or young child. Additionally or alternatively, the screen description 38 can indicate the relevance of protein to the allergy state of the infant or young child. For example, the screen description 38 can comprise a message that cow's milk proteins may not be suitable for the infant or young child due to these proteins being a foreign protein to the human body and one of the most common food allergens.

The user can enter the information into the data fields 32 using any known input component of the device 10 providing the interactive tool, such as a keyboard, a touchscreen, a trackball, and the like, and the present disclosure is not limited to a specific embodiment of the input component of the device 10.

The device 10 providing the interactive tool can perform an analysis of the information entered into the data fields 32 of the allergy assessment screen 31. For example, the allergy assessment screen 31 can comprise a button, and selection of this button can prompt the device 10 providing the interactive tool to analyze the information. The interactive tool may have criteria by which the information is analyzed and/or with which the information is compared. For example, the criteria can specify the presence or absence of factors for health development. As another example, the criteria can comprise one or more thresholds for comparison with the information entered into the data fields 32 and/or for comparison with values derived from the information entered into the data fields 32.

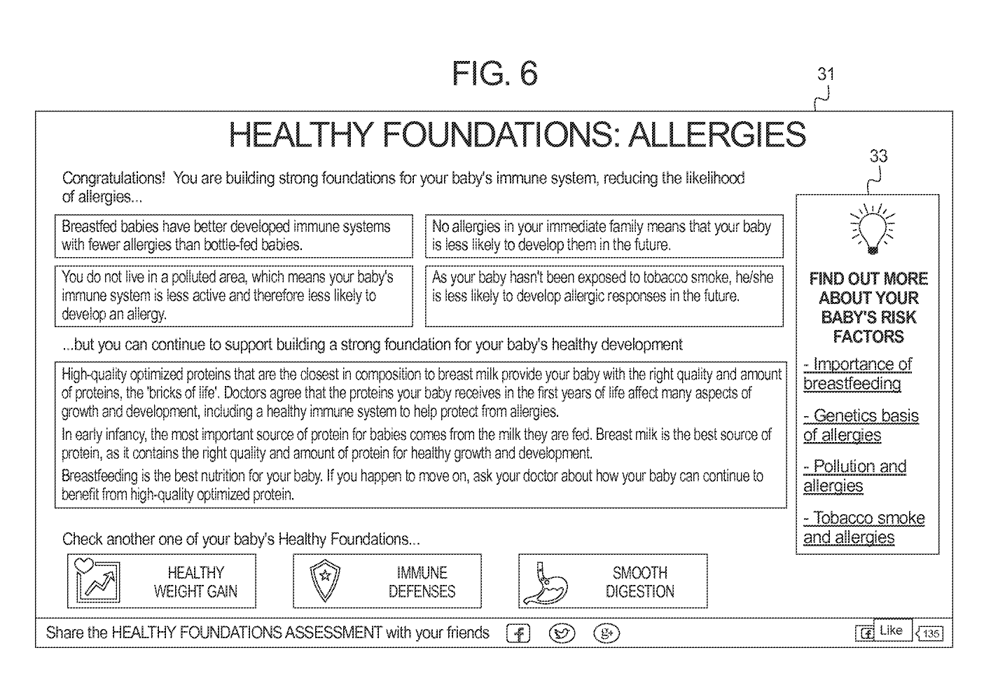

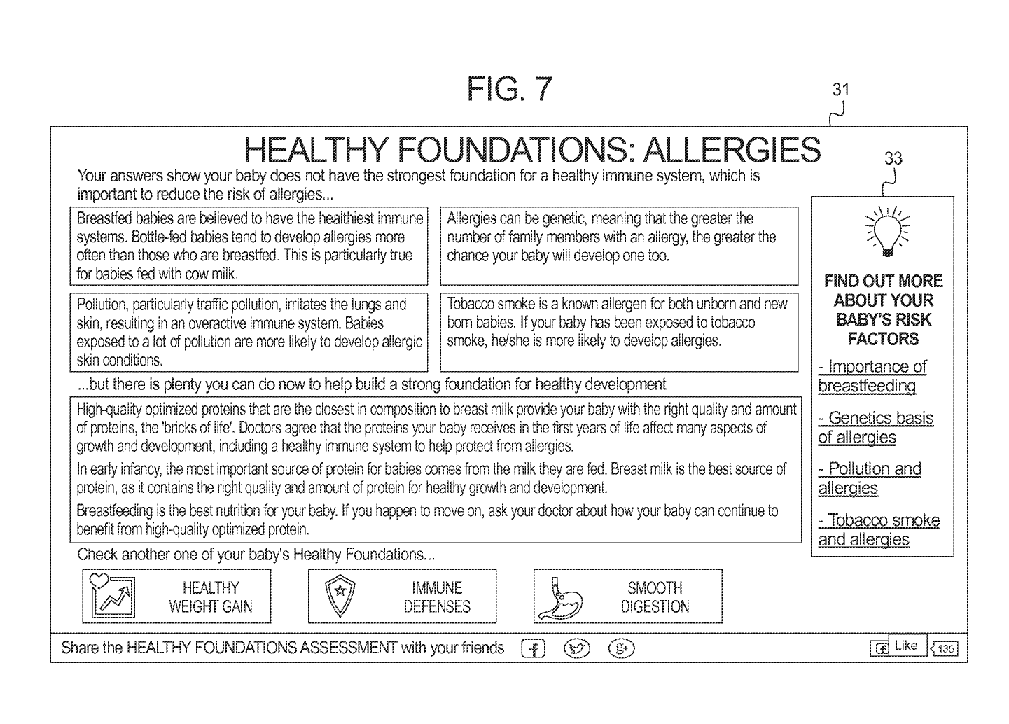

In a preferred embodiment, the device 10 providing the interactive tool can determine if the infant or young child has an immediate risk of allergy and/or a risk of allergy later in life and display the determination in the user interface, for example in the allergy assessment screen 31 (FIGS. 6 and 7), such as by updating the allergy assessment screen 31 or providing a completely new version of the allergy assessment screen 31. The device 10 providing the interactive tool can use the information entered into the data fields 32 to determine if the infant or young child has an immediate risk of allergy and/or a risk of allergy later in life.

The information entered into the user interface can be analyzed as sub-factors for whether the infant or young child has an immediate risk of allergy and/or a risk of allergy later in life, preferably using an algorithm. As examples of the analysis in this determination, the device 10 providing the interactive tool can determine the presence or absence of one or more of the following sub-factors: whether the infant or young child is/was exclusively breastfed for the first 6 months after birth; whether one of the parents has an allergy history; whether any direct relatives have an allergy history; if the family lives in a polluted city; whether the infant or young child lives in an environment with second-hand smoke or was the mother exposed to tobacco smoke during pregnancy; and any combinations thereof.

Accordingly, the device 10 providing the interactive tool can determine if the infant or young child has an immediate risk of allergy and/or a risk of allergy later in life using sub-factors determined by the information entered into the data fields 32 of the allergy assessment screen 31. As shown in FIGS. 6 and 7, the device 10 can identify which of the allergy sub-factors are fulfilled and which of the allergy sub-factors are not fulfilled.

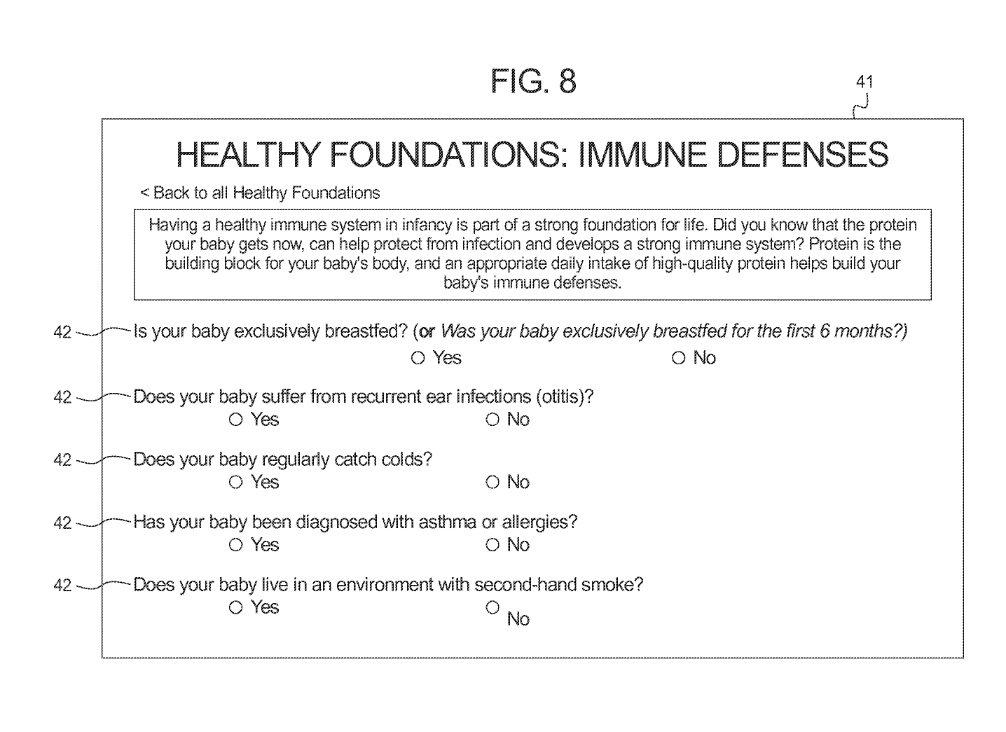

As shown in FIGS. 8-10, the device 10 providing the interactive tool can provide one or more immunity assessment screens 41 (hereafter “the immunity assessment screen 41”) in the user interface, for example in response to user input selecting a corresponding button from the buttons 13. The immunity assessment screen 41 can provide data fields 42 in which the user can enter information regarding the immunity of the infant or young child. Non-limiting examples of such information include whether the infant or young child is/was exclusively breastfed for the first 6 months after birth, whether the infant or young child suffers from recurrent ear infections, whether the infant or young child regularly catches colds, whether the infant or young child has been diagnosed with asthma or allergies, whether the infant or young child lives in an environment with second hand smoke, and any combinations thereof.

The immunity assessment screen 41 can display information icons 43 adjacent the data fields 42. A user can select one of the information icons 43 to obtain further information related to the inquiry associated with the one of the data fields 42 corresponding to the selected information icon 43. For example, the further information can indicate why the corresponding inquiry is relevant to the health of the infant or young child. The further information can be displayed on the same screen as the data fields 42, for example as a pop-up box, or can be displayed on a different screen.

The immunity assessment screen 41 can display a screen description 48 that can indicate why the immunity of the infant or young child has an impact on the health later in life for the infant or young child. Additionally or alternatively, the screen description 48 can indicate the relevance of protein to the immunity of the infant or young child. For example, the screen description 48 can comprise a message that the gut is the biggest immune organ of the body, and current protein intake influences the presence of good bacteria in the gut and can help train the immune system. In an embodiment, the immunity assessment screen 41 can indicate that the first years of life are critical for the developing immune system, and the immune defenses of the infant or young child can easily be altered during this time; and/or the immunity assessment screen 41 can indicate that development of a healthy immune system is essential for protecting the infant or young child from illnesses caused by viruses and bacteria.

The user can enter the information into the data fields 42 using any known input component of the device 10 providing the interactive tool, such as a keyboard, a touchscreen, a trackball, and the like, and the present disclosure is not limited to a specific embodiment of the input component of the device 10.

The device 10 providing the interactive tool can perform an analysis of the information entered into the data fields 42 of the immunity assessment screen 41. For example, the immunity assessment screen 41 can comprise a button, and selection of this button can prompt the device 10 providing the interactive tool to analyze the information. The interactive tool may have criteria by which the information is analyzed and/or with which the information is compared. For example, the criteria can specify the presence or absence of factors for health development. As another example, the criteria can comprise one or more thresholds for comparison with the information entered into the data fields 42 and/or for comparison with values derived from the information entered into the data fields 42.

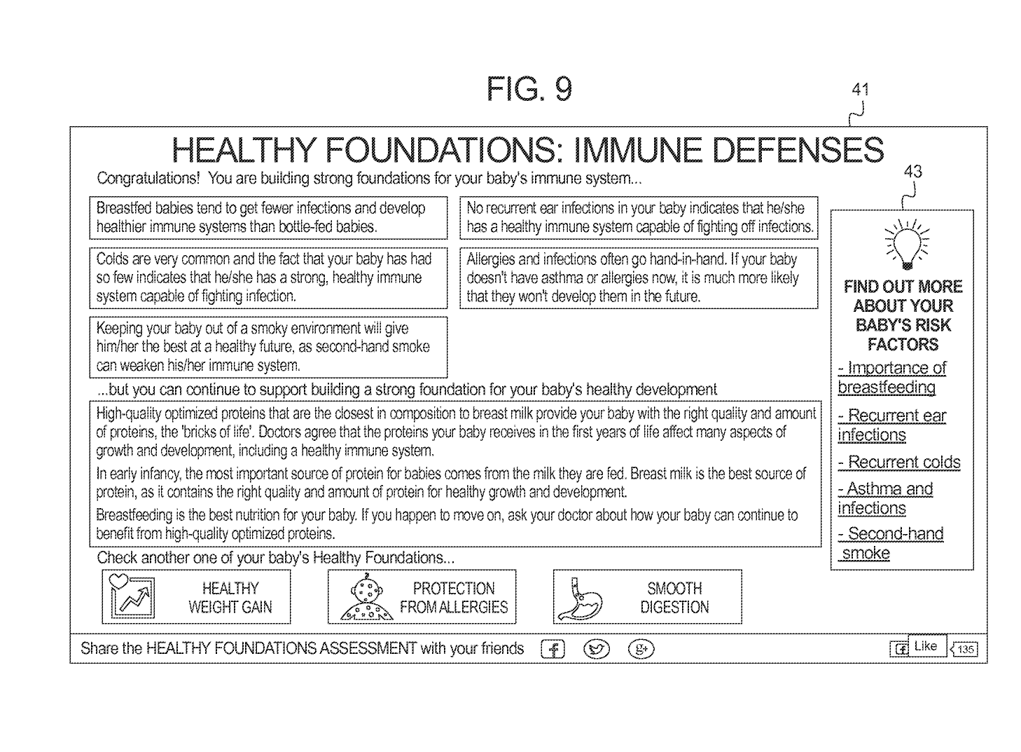

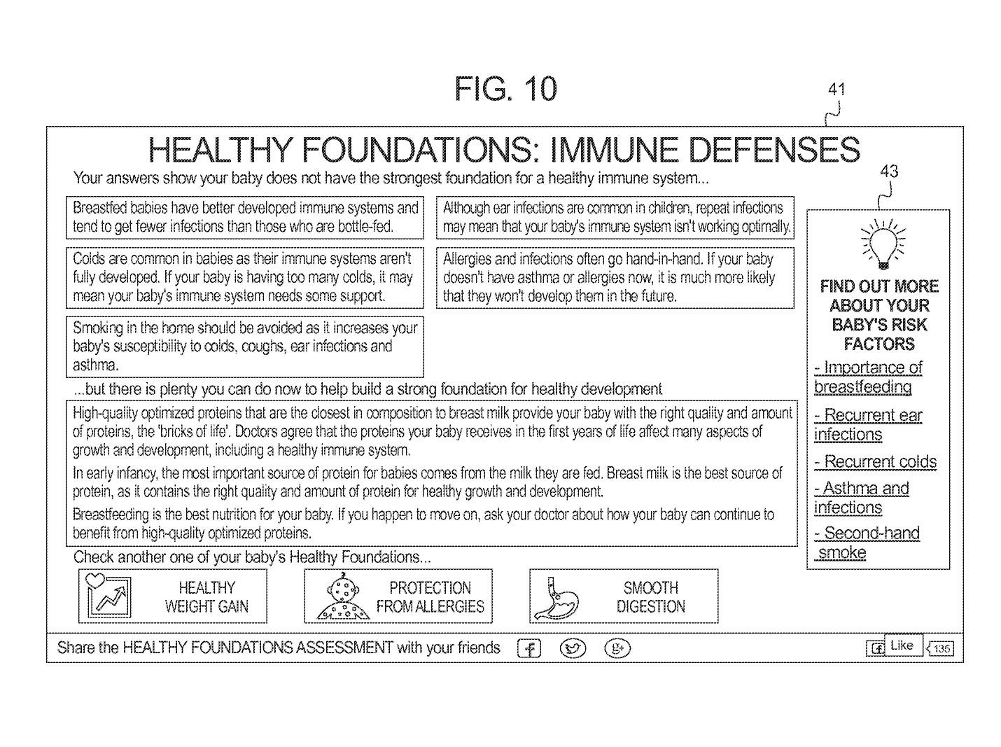

In a preferred embodiment, the device 10 providing the interactive tool can determine if the infant or young child has an immediate risk of an underdeveloped immune system and/or a risk of an underdeveloped immune system later in life and display the determination in the user interface, for example in the immunity assessment screen 41 (FIGS. 9 and 10), such as by updating the immunity assessment screen 41 or providing a completely new version of the immunity assessment screen 41. The device 10 providing the interactive tool can use the information entered into the data fields 42 to determine if the infant or young child has an immediate risk of an underdeveloped immune system and/or a risk of an underdeveloped immune system later in life.

The information entered into the user interface can be analyzed as sub-factors for the immediate risk of an underdeveloped immune system and/or the risk of an underdeveloped immune system later in life, preferably using an algorithm. As examples of the analysis in this determination, the device 10 providing the interactive tool can determine the presence or absence of one or more of the following sub-factors: whether the infant or young child is/was exclusively breastfed for the first 6 months after birth, whether the infant or young child suffers from recurrent ear infections, whether the infant or young child regularly catches colds, whether the infant or young child has been diagnosed with asthma or allergies, whether the infant or young child lives in an environment with second hand smoke, and any combinations thereof.

Accordingly, the device 10 providing the interactive tool can determine if the infant or young child has an immediate risk of an underdeveloped immune system and/or a risk of an underdeveloped immune system later in life using sub-factors determined by the information entered into the data fields 42 of the immunity assessment screen 41. As shown in FIGS. 9 and 10, the device 10 can identify which of the immunity sub-factors are fulfilled and which of the immunity sub-factors are not fulfilled.

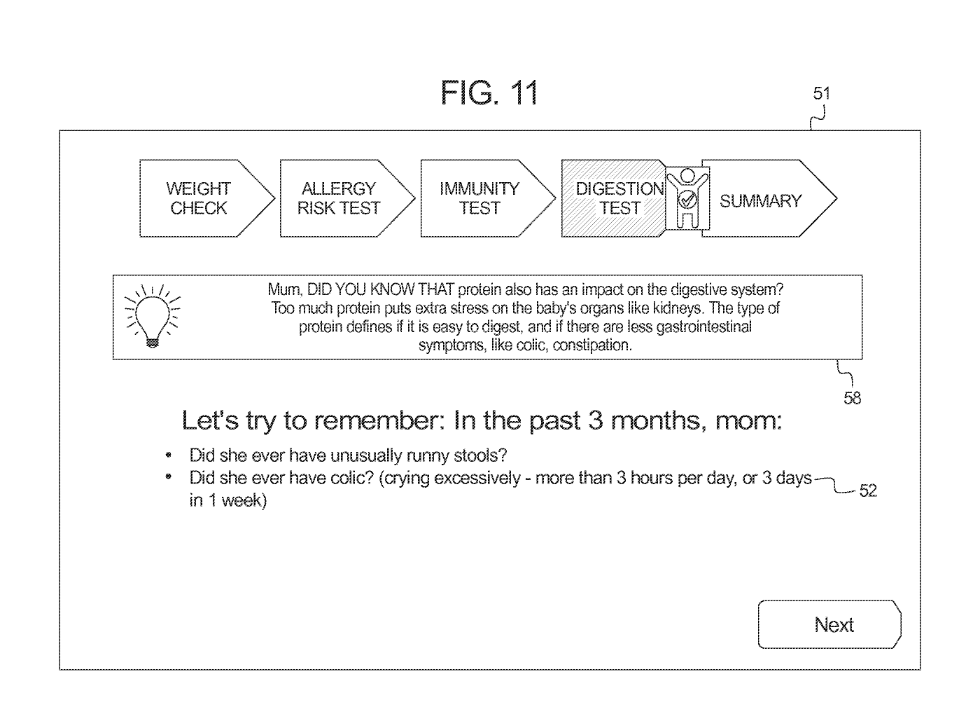

As shown in FIG. 11, the device 10 providing the interactive tool can provide one or more digestion assessment screens 51 (hereafter “the digestion assessment screen 51”) in the user interface, for example in response to user input selecting a corresponding button from the buttons 13. The digestion assessment screen 51 can provide data fields 52 in which the user can enter information regarding the digestive system of the infant or young child. Non-limiting examples of such information include whether the infant or young child ever has unusually runny stools, whether the infant or young child ever had colic, whether the infant or young child has difficulty passing stools and/or has very hard stools, whether the infant or young child regularly spits up their feed, and any combinations thereof.

The digestion assessment screen 51 can display information icons (not shown) adjacent the data fields 52. A user can select one of the information icons to obtain further information related to the inquiry associated with the one of the data fields 52 corresponding to the selected information icon. For example, the further information can indicate why the corresponding inquiry is relevant to the health of the infant or young child. The further information can be displayed on the same screen as the data fields 52, for example as a pop-up box, or can be displayed on a different screen.

The digestion assessment screen 51 can display a screen description 58 that can indicate why the digestion of the infant or young child has an impact on the health later in life for the infant or young child. Additionally or alternatively, the screen description 58 can indicate the relevance of protein to the digestion of the infant or young child. For example, the screen description 58 can comprise a message that protein has an impact on the digestive system: too much protein puts stress on the organs of the infant or young child, such as the kidneys, and the type of protein determines if the protein is easy to digest and causes less gastrointestinal symptoms such as colic and constipation.

The user can enter the information into the data fields 52 using any known input component of the device 10 providing the interactive tool, such as a keyboard, a touchscreen, a trackball, and the like, and the present disclosure is not limited to a specific embodiment of the input component of the device 10.

The device 10 providing the interactive tool can perform an analysis of the information entered into the data fields 52 of the digestion assessment screen 51. For example, the digestion assessment screen 51 can comprise a button, and selection of this button can prompt the device 10 providing the interactive tool to analyze the information. The interactive tool may have criteria by which the information is analyzed and/or with which the information is compared. For example, the criteria can specify the presence or absence of factors for health development. As another example, the criteria can comprise one or more thresholds for comparison with the information entered into the data fields 52 and/or for comparison with values derived from the information entered into the data fields 52.

In a preferred embodiment, the device 10 providing the interactive tool can determine if the infant or young child has an immediate risk of a not well-functioning digestive system (e.g. not a smooth digestion) and display the determination in the user interface, for example in the digestion assessment screen 51, such as by updating the digestion assessment screen 51 or providing a completely new version of the digestion assessment screen 51. The device 10 providing the interactive tool can determine if the infant or young child has an immediate risk of a not well-functioning digestive system using the information entered into the data fields 52.

The information entered into the user interface can be analyzed as sub-factors for the immediate risk of a not well-functioning digestive system, preferably using an algorithm. As examples of the analysis in determination of whether the infant or young child has an immediate risk of a not well-functioning digestive system, the device 10 providing the interactive tool can determine the presence or absence of one or more of the following sub-factors: whether the infant or young child ever has unusually runny stools, whether the infant or young child ever had colic, whether the infant or young child has difficulty passing stools and/or has very hard stools, whether the infant or young child regularly spits up their feed, and any combinations thereof.

Accordingly, the device 10 providing the interactive tool can determine if the infant or young child has an immediate risk of a not well-functioning digestive system using sub-factors determined by the information entered into the data fields 52 of the digestion assessment screen 51. The device 10 can identify which of the sub-factors for an immediate risk of a not well-functioning digestive system are fulfilled and which of the sub-factors for an immediate risk of a not well-functioning digestive system are not fulfilled.

Other information and criteria not known to be related to the risk factors at the time of this patent application but later discovered to be a factor can be used by the interactive tool provided by the device 10, and the present disclosure is not limited to the above examples of the information and the criteria. The information and the criteria can be any information and criteria found to be related to risks to the health development later in life of an infant or young child.

In a preferred embodiment, the inquiries and/or the criteria by which the device 10 providing the interactive tool analyzes the information are periodically updated. For example, if a newly identified factor for the health development of an infant or young child is identified, the interactive tool can be updated so that subsequent uses of the interactive tool determine whether the newly identified factor is present. The interactive tool can provide an additional data field and/or can perform additional analysis as a result of the update. As another example, if criteria by which the interactive tool analyzes the information changes, the interactive tool can use the new criteria in analysis of the factors for the health development of an infant or a young child.

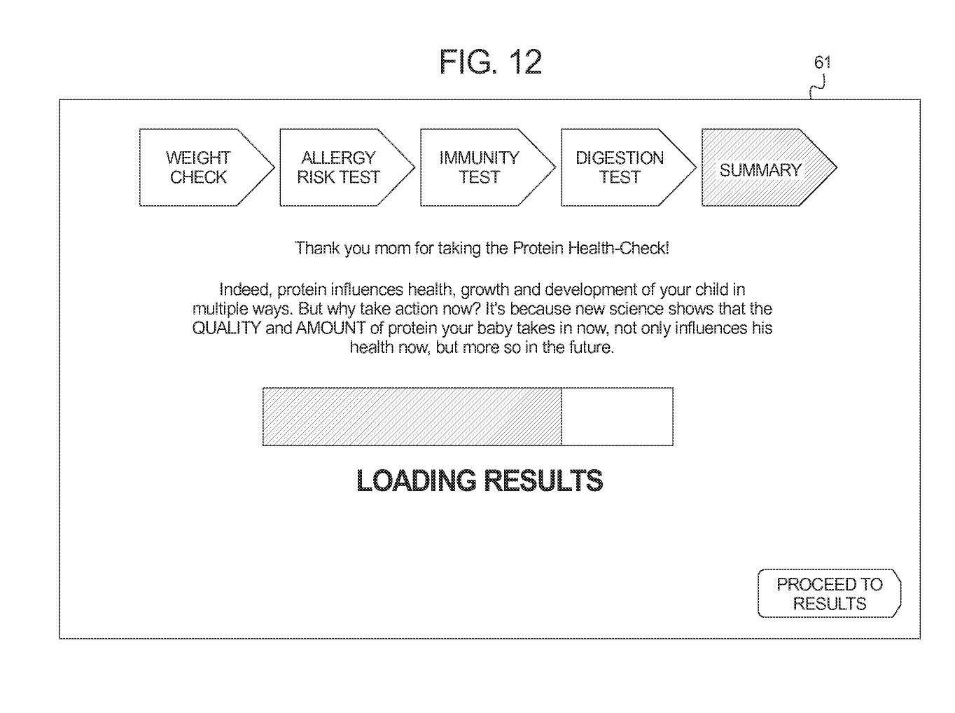

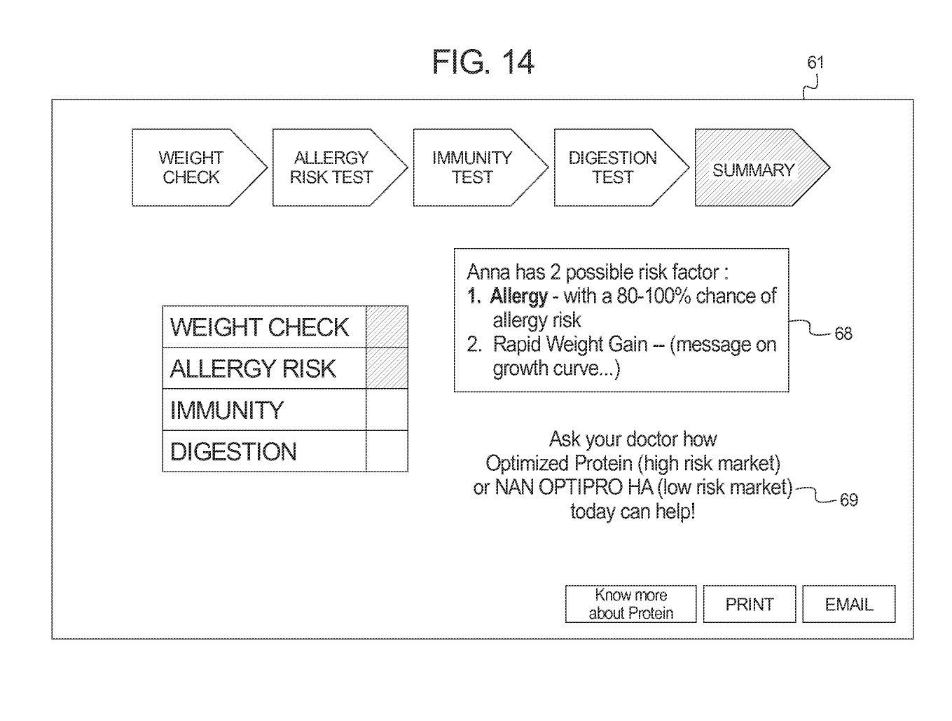

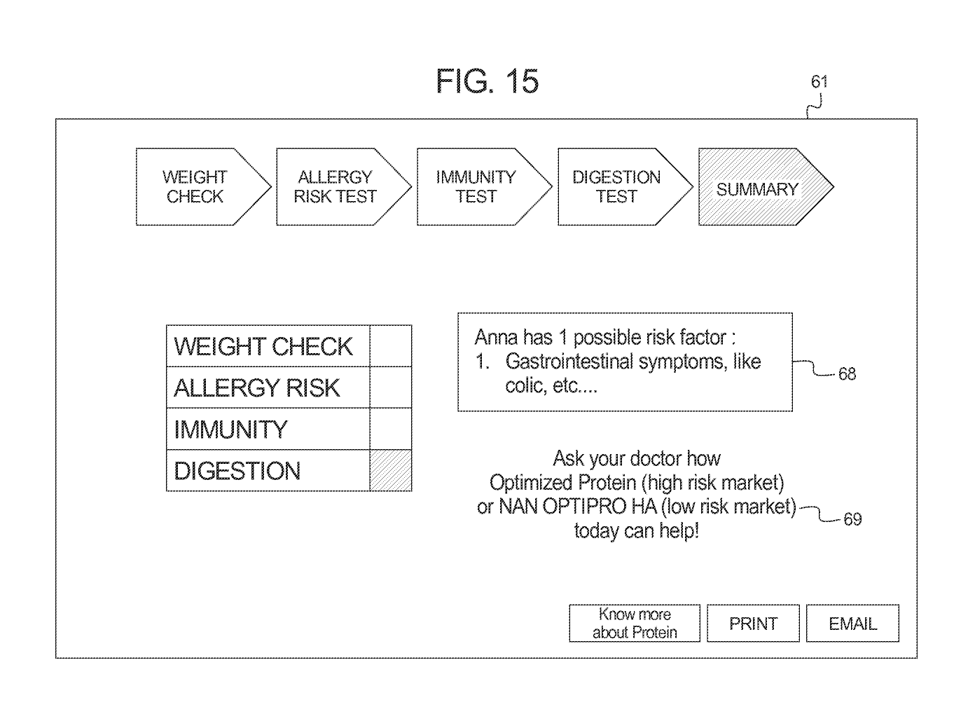

The results of the analysis regarding the four factors can be provided in the user interface of the device 10 providing the interactive tool. As shown in FIGS. 12-15, the device 10 providing the interactive tool can display one or more summary screens 61 (hereafter “the summary screen 61”). While the device 10 providing the interactive tool is performing the analysis, the summary screen 61 can comprise an “analysis progress” section that indicates an amount of completion of the analysis (FIG. 12). In such an embodiment, the summary screen 61 can additionally or alternatively display educational information, for example information indicating that the quality and amount of protein administered to the infant or young child influences both current health and health later in life for the infant or young child.

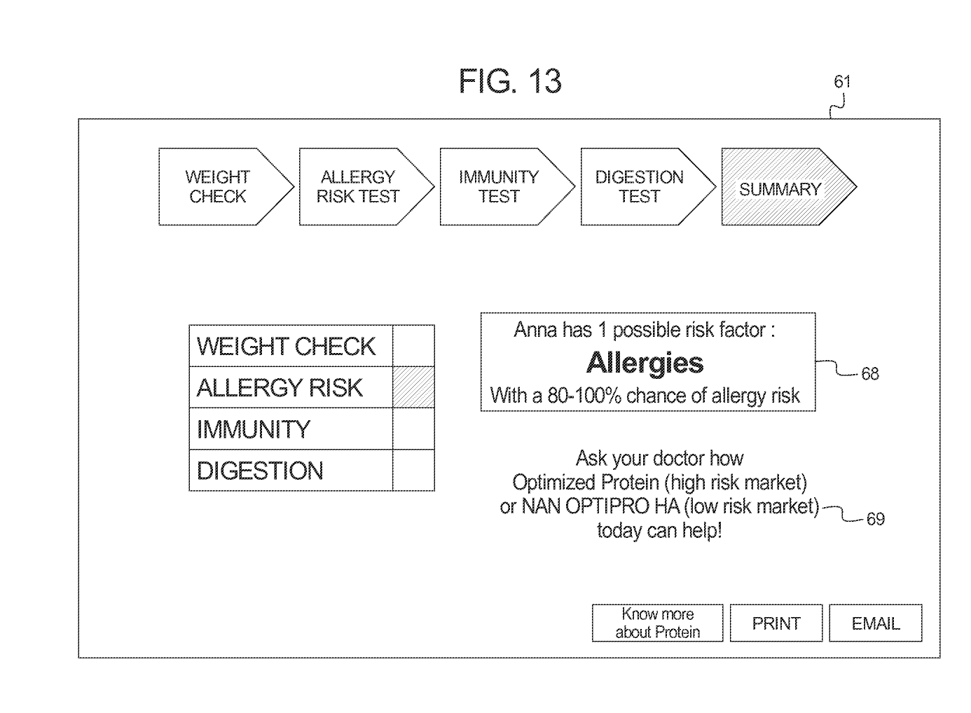

As shown in FIGS. 13-15, the evaluation summary screen 61 can provide a summary 68 that identifies how many risk factors for the infant or young child were evaluated and how many factors were present or absent. For example, the summary 68 can identify zero risk factor out of four, one factor out of four, two factors out of four, three factors out of four, or all of the four factors. Alternatively or additionally, at least a portion of the information provided by the evaluation summary screen 61 can be provided on other screens, such as the growth assessment screen 21, the allergy assessment screen 31, the immunity assessment screen 41 and/or the digestion assessment screen 51, for example after a user submits the information into one of these screens.

The summary screen 61 may identify any health development factor or sub-factor that was not analyzed and/or may display a suggestion that such a factor or sub-factor be monitored and entered into the interactive tool. For example, the summary screen 61 may indicate that the weight gain of the infant or young child is considered a factor for an immediate risk of obesity and/or a risk of obesity later in life and suggest that the weight and length of the infant or young child be entered into the interactive tool periodically to monitor this sub-factor related to the growth of the infant or young child. In such an embodiment, the summary screen 61 may indicate that a risk of obesity later in life is based on the percentile of the weight-for-length of the infant or young child relative to other infants or young children of the same age and gender, and this factor is present if the weight-for-length of the infant or young child increases by at least one major percentile.

The summary screen 61 can specify a preliminary conclusion regarding one or more of the risk factors, for example the immediate risk of obesity and/or the risk of obesity later in life. In a preferred embodiment, these factors comprise at least four sub-factors, namely whether the mother was overweight or obese before pregnancy, the birth weight of the infant, whether the mother is/was breastfeeding the infant or young child or not, and a rapid weight gain of the infant or the young child. Other obesity sub-factors that are not known at the time of this patent application but later discovered to be a factor can be evaluated by the interactive tool provided by the device 10, and the present disclosure is not limited to the above examples of obesity sub-factors. The obesity sub-factors can be any sub-factors related to the immediate risk of obesity and/or the risk of obesity later in life for an infant or a young child.

For each of the risk factors, the summary screen 61 can specify whether the risk factor is present or not. In an alternative embodiment, the summary 68 can comprise a value on a sliding scale. In such an embodiment, the interactive tool can assign a multiplier to each of the sub-factors, determine which sub-factors are present, and then determine a value associated with the corresponding risk factor. For example, the interactive tool can use the information regarding the growth of the infant or young child to assign a value for each sub-factor for the risk of obesity later in life. The multiplier can be based on how much the corresponding sub-factor affects the risk of obesity later in life. For example, some previous studies (Horta B L et al., WHO Press 2007; Salsberry P J et al., Pediatrics, 2005 December; 116(6):1329-38; Taveras E M et al., Arch Pediatr Adolesc Med. 2011; 165(11):993-8; Yu Z B et al., Obes Rev. 2011 July; 12(7):525-42) have suggested that a lack of breastfeeding increases the risk by 28%, the mother having a BMI equal to or exceeding 25 kg/m² before pregnancy increases the risk by 191%, a birth weight of the infant over 4 kg increases the risk by 107%, and rapid weight gain such that the weight of the infant or young child relative to infants or young children of the same age and gender increases by at least one major percentile increases the risk by 108%. The multipliers can be determined accordingly. In such an embodiment, the value associated with the risk of obesity later in life can be based on an amount by which information entered into the data fields 22 exceeds or falls below a threshold, for example the amount by which the BMI of the mother exceeds or falls below 25 kg/m² and/or the amount by which the birth weight of the infant exceeds or falls below 4 kg.

As another example, a previous study (Gdalevich M et al., J Am Acad Dermatol. 2001 October; 45(4):520-7) conducted a systematic review with meta-analysis of prospective studies that evaluated the association between exclusive breast-feeding during the first 3 months after birth and atopic dermatitis. The summary odds ratio (OR) for the protective effect of breast-feeding in the studies analyzed was 0.68 (95% confidence interval [CI], 0.52-0.88). This effect estimate was higher in the group of studies wherein children with a family history of atopy were investigated separately (OR=0.58; CI, 0.41-0.92) than in those of combined populations (OR=0.84; CI, 0.59-1.19). The multipliers can be determined accordingly.

The device 10 providing the interactive tool can enable the user to sequentially and/or periodically input the weight and length of the infant or young child so that the weight gain is monitored and evaluated by the interactive tool. In such embodiments, the device 10 providing the interactive tool preferably creates a profile for the user such that the profile includes the sequential and/or periodic weight and length measurements. The profile can also include other information about the infant or young child that is input into the data fields 12, 22,32,42,52. The device 10 providing the interactive tool can enable the user to edit the profile using the user interface.

The device 10 providing the interactive tool can store at least a portion of the profile. Alternatively or additionally, a remotely located database can store at least a portion of the profile. In an embodiment, the remotely located database is connected to the device 10 by a wireless network, such as the internet. The device 10 providing the interactive tool can enable the user to access the information in the profile, for example for sharing the information in the profile with a pediatrician.

The user can utilize the device 10 providing the interactive tool to sequentially enter a plurality of weights and lengths of the infant or young child, and the interactive tool may generate and/or update the growth curve of the infant or young child, for example by interpolating and/or extrapolating the growth curve. The graph may additionally display one or more reference growth curves, and each reference growth curve can be associated with a percentile of infants or young children of the same age and gender. Preferably the growth curve (or weight gain) of the infant or young child and/or the reference growth curves are for at least the first six months after birth. The growth curve can be based at least partially on at least two weight-for-length values of the infant or young child after birth and the corresponding ages, preferably at least three weight-for-length values of the infant or young child after birth and the corresponding ages, more preferably at least four weight-for-length values of the infant or young child after birth and the corresponding ages, and most preferably at least five weight-for-length values of the infant or young child after birth and the corresponding ages. The intervals between the different weights and lengths measures of the infant or young child after birth can be fixed (for example the weights and lengths are determined every week, every two weeks, every month or every two months . . . ) or randomly (for example a first measure is made after 1 week of birth, then a second one after 1 month of birth then a third one after 3 months of birth, then a fourth one after 6 months of birth . . . ).

The user can enter the plurality of weights and lengths measures using any known input component of the device 10 providing the interactive tool, such as a keyboard, a touchscreen, a trackball, and the like, and the present disclosure is not limited to a specific embodiment of the input component of the device 10. For example, if the device 10 has a touchscreen, the user can touch a section of the graph to input a weight in association with an age.

If the user enters a new data point for the growth curve, the device 10 providing the interactive tool can perform an analysis of the growth curve to determine whether a risk of obesity later in life is present. The device 10 can perform the analysis in response to user input requesting the analysis or can automatically perform the analysis in response to entry of the new data point. Preferably the analysis comprises, for each data point, a determination of which percentile of infants or young children of the same age and gender encompasses the weight-for-length and further comprises comparison of the percentiles of the different ages of the infant or young child to each other. For example, the analysis can determine that this factor is present if the weight gain of the infant or young child increases by at least one major percentile.

In an embodiment, results of the analysis of the growth curve are provided on the summary screen 61. For example, the summary screen 61 can specify an updated conclusion regarding the immediate risk of obesity and/or the risk of obesity later in life. The evaluation summary screen can indicate that the BMI of the mother before pregnancy, the birth weight of the infant, whether the mother is breastfeeding the infant or not, and the weight gain of the infant or young child were evaluated. The conclusion on the summary screen 61 can be updated automatically each time a new data point is entered for the growth curve and/or can be updated when requested by input into the user interface of the device 10 by the user.

If the weight gain (or growth curve) shows that the weight-for-length of the infant or young child is close to increasing by at least one major percentile, the interactive tool can provide a warning in the user interface of the device 10. The warning can be text and/or graphics. In an embodiment, the warning can comprise a message that may be an educational information; an alert on the risk for the infant or the young child to become obese, or a recommendation suggesting a visit to a healthcare professional who may provide a nutritional suggestion, i.e. a recommendation of a nutritional composition or a set of nutritional compositions for the infant or the young child.

Additional information or functionality can be provided by the summary screen 61 and/or another screen of the user interface of the device 10 providing the interactive tool. For example, the additional information or functionality can comprise an indication that the profile and the results of the analysis thereof are stored by the interactive tool, a recommendation that the profile and the results of the analysis thereof should be shared with a pediatrician, a recommendation that the parent take the infant or young child to a pediatrician, an interactive quiz or game highlighting the potential burden of obesity for the infant or young child, a button for sharing the interactive tool with friends and family, an explanation of one or more of the buttons provided in the user interface, and/or a “close” button to end the current session of the interactive tool.

The interactive tool provided by the device 10 can provide a message 69 based at least partially on the information related to the risk factors of the infant or the young child. The message 69 may comprise educational information and/or a recommendation suggesting a visit to a health care professional who may provide optimized protein solutions (e.g. a recommendation of a nutritional composition or of a set of nutritional compositions for the infant or the young child with adapted protein quality/quantity).

The message 69 on the summary screen 61 can alert parents of the infant/young child to a health risk for their infant or young child and, for example, may advise the parents to consult a health care professional for advice on possible nutritional solutions (i.e. optimized protein solutions). The nutritional suggestion from the health care professional can comprise identification of a composition or a set of nutritional compositions (e.g. an age-tailored system) for administration to the infant or young child, such as a type of starter infant formula, follow-up or follow-on infant formula, growing up milk, supplements, or the like. In an embodiment, instructions for obtaining and/or using the interactive tool can be included with a nutritional composition, for example on the packaging of the nutritional composition. In an embodiment, instructions for obtaining and/or using the interactive tool can be sent to a consumer that purchased the nutritional composition, for example by email, text message, SMS, voicemail, hard copy mail, or any means known to one skilled in the art.

As a specific non-limiting example, the nutritional suggestion from the health care professional can be a nutritional composition such as an infant formula which provides a protein quality and quantity closer to that of breast fed infants when the infant is not breast fed. As another specific non-limiting example, the optimized protein solution suggested from the health care professional can be a nutritional composition which provides a specific certain protein content and/or a specific energy content and/or a specific lipid content and/or a certain type of protein (e.g. a specific source of protein such as a particular whey:casein ratio, or a specific degree of protein hydrolysis . . . ). The health care professional can also suggest adapting the ingested quantity of a nutritional composition.

In an embodiment, the health care professional can recommend, as an optimized protein solution, the infant formula disclosed in U.S. patent application Ser. No. 12/519,043 published as U.S. 2010/0092610 on Apr. 15, 2010, herein incorporated by reference in its entirety. For example, the nutritional suggestion can be feeding the infant a nutritional composition comprising a protein source, a lipid source and a carbohydrate source and having a protein content of less than 1.8 g/100 kcal and an energy density of less than 650 kcal/liter. The nutritional composition can have a characteristic that is one or more of a protein content between 1.4 and 1.7 g/100 kcal; a casein:whey ratio from 70:30 to 30:70, such as 40:60; free amino acids such that the composition comprises the minimum requirements for essential amino acid content; a carbohydrate content between 9 and 14 g/100 kcal; a lipid content between 4.4 and 6 g/100 kcal; a ratio of linoleic acid (C18:2n-6): α-linolenic acid (C18:3n-3) less than 7:1, such as between 7:1 and 5:1; a ratio of arachidonic acid (C20:4n-6):docosahexaenoic acid (C22:6n-3) between 2:1 and 1.1; all vitamins and minerals understood to be essential in the daily diet in nutritionally significant amounts; probiotic bacteria; dietary fibers; lactoferrin; nucleotides; or nucleosides. The protein may be intact, hydrolysed (partially or fully) or it can be a mixture thereof. In an embodiment, the health care professional can recommend that this composition is fed to an infant as the sole source of nutrition from the age of three months and subsequently as part of a mixed diet during the introduction of solid foods until weaning is complete at about the age of 12 months. In a particular embodiment, the nutritional composition may contain modified sweet whey (MSW) that may be obtained using the process described in WO98/53702 (fully incorporated by reference). For example, the optimized protein solution might be an infant formula such as Nan 1 from Nestlé, comprising 1.8 g protein/100 kcal, with MSW whey and a whey:casein ratio of 70/30. Another example of optimized protein solutions can be an infant formula such as Nan HA 1 from Nestlé, comprising 1.9 g protein/100 kcal, with 100% whey that is partially hydrolysed.

The health care professional can recommend an age-tailored nutritional composition system. The age-tailored nutritional composition system can comprise a mix of different kinds of compositions, for example selected from the list consisting of starter infant formula, follow-up or follow-on infant formula, growing up milks, supplements, or the like. The age-tailored nutritional composition system can also comprise different compositions belonging to the same types, for example it may be an age-tailored infant formula system, which is a system comprising several infant formula. For example, a first infant formula is fed to the infant in a first stage, such as from birth to at least two months and preferably to three months, and a second infant formula is fed to the infant thereafter until, for example, nine, twelve or eighteen months.

The first infant formula can have a protein content of at least 1.8 g/100 kcal, preferably from 1.8 to 2.5 g/100 kcal, such as from 1.8 to 2.0 g/100 kcal or from 1.9 to 2.0 g/100 kcal. In a particular embodiment, the amount of protein of the first infant formula is higher than 2.0 g/100 kcal, such as from 2.05 to 2.5 g/100 kcal. The second infant formula can have a protein content below 1.7 g/100 kcal. In an embodiment, the protein content in the second infant formula is below 1.69 g/100 kcal, such as below 1.68 g/100 kcal, preferably below 1.67 g/100 kcal, even more preferably below 1.66 g/100 kcal. In another embodiment, the second infant formula comprises protein in an amount from 1.4 to 1.69 g/100 kcal, such as from 1.4 to 1.68 g/100 kcal, such as from 1.5 to 1.67 g/100 kcal, such as from 1.5 to 1.66 g/100 kcal, preferably from 1.55 to 1.65 g/100 kcal. Both infant formulas also supply sufficient quantities of other nutrients which are essential for growth and development.

The age-tailored infant formula system suggested by the health care professional can comprise additional infant formulas with lower amounts of protein present than the second infant formula. For example, the second infant formula may comprise 1.67 g protein/100 kcal, while a third infant formula comprises 1.62 g protein/100 kcal and a fourth infant formula comprises 1.57 g protein/100 kcal.

Another example of an age-tailored nutritional composition system can be made by a succession of at least three nutritional compositions, for example at least two infant formulas and one growing-up milk. There may be a succession of one, two, three or more infant formulas followed by a succession of one, two, three or more growing-up milks. The protein amount may vary over the ages, and especially decrease over the ages, as well as the whey:casein ratio. In an embodiment, the age-tailored nutritional composition system may comprise:

a first nutritional composition (e.g. infant formula) with protein in an amount of 1.75-3.0 g/100 kcal, that may be administered to the infant from birth and until 3-6 months after birth of said infant,

a second nutritional composition (e.g. infant formula) with protein in an amount of 1.5-1.75 g/100 kcal, that may be administered to the infant from 3-6 months and until 1 year after birth of said infant,

a third nutritional composition (e.g. growing-up milk) with protein in an amount comprised between 1.3 and 1.5 g/100 kcal, that may be administered to the young child after 12 months, such as from 1 to 2 years or from 1 to 3 years.

In another embodiment the age-tailored nutritional composition system may comprise:

a first nutritional composition (e.g. infant formula) with protein in an amount of 2.4-3.0 g/100 kcal, that may be administered to the infant from birth and until the first 3 to 15 days,

a second nutritional composition (e.g. infant formula) with protein in an amount of 1.75-2.4 g/100 kcal, that may be administered from the first 3 to 15 days and until 3 months after birth of the infant,

a third nutritional composition (e.g. infant formula) with protein in an amount of 1.5-1.75 g/100 kcal, that may be administered to the infant from 3 months and until 1 year after birth of said infant,

a fourth nutritional composition (e.g. growing-up milk) with protein in an amount comprised between 1.3 and 1.5 g/100 kcal, that may be administered to the young child after 12 months, such as from 1 to 2 years or from 1 to 3 years.

In another embodiment of the present invention, the age-tailored nutritional composition system may comprise:

a first nutritional composition (e.g. infant formula) with protein in an amount of 2.4-3.0 g/100 kcal, that may be administered to the infant from birth and until the first 3 to 15 days,

a second nutritional composition (e.g. infant formula) with protein in an amount of 1.9-2.4 g/100 kcal, that may be administered from the first 3 to 15 days and until 1 month after birth of the infant,

a third nutritional composition (e.g. infant formula) with protein in an amount of 1.75-1.9 g/100 kcal, that may be administered from 1 month and until 3 months after birth of the infant,

fourth nutritional composition (e.g. infant formula) with protein in an amount of 1.5-1.75 g/100 kcal, that may be administered to the infant from 3 months and until 1 year after birth of said infant,

a nutritional composition (e.g. growing-up milk) with protein in an amount comprised between 1.3 and 1.5 g/100 kcal, that may be administered to the young child after 12 months, such as from 1 to 2 years or from 1 to 3 years.

These examples are for illustrative purposes only.

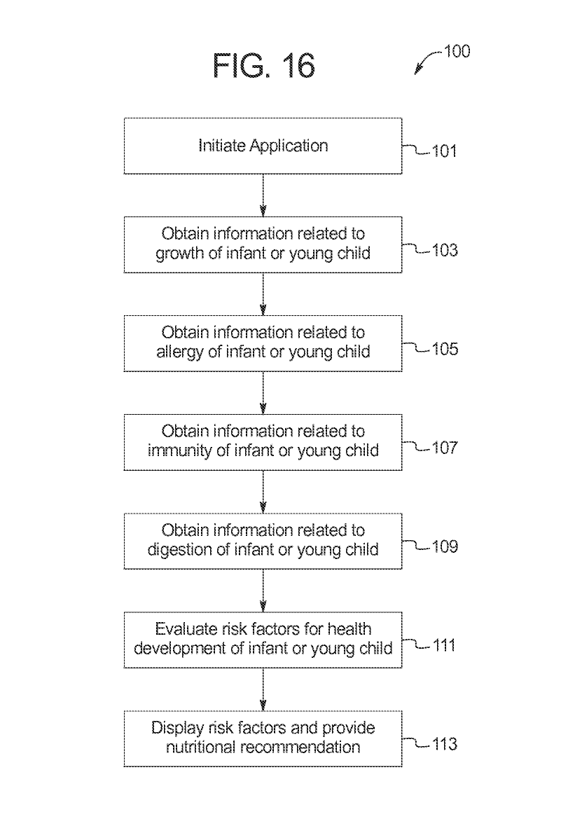

FIG. 16 generally illustrates a flowchart of an embodiment of a method 100 provided by the present disclosure. The method 100 can be implemented on a device comprising a processor, for example a mobile telephone, such as a smartphone; a laptop computer; a desktop personal computer; a tablet; or a personal digital assistant.

In Step 101, the interactive tool can be initiated, and initiation of the interactive tool can comprise purchasing the program from an application store, downloading the program onto the device comprising the processor, accessing the program over the internet using a web browser of the device, or the like. A remotely located database can transmit the program to the device and/or host a website accessible to the device. In an embodiment, initiation of the interactive tool comprises selecting an icon associated with the interactive tool in a user interface of the device.

In Step 103, the interactive tool can obtain information related to the risk of obesity, immediate and/or later in life, for an infant or young child. Preferably the user of the device manually enters the information into the interactive tool using the device. In an embodiment, the interactive tool provides data fields in the user interface of the device requesting the information. The information can be, for example, the weight of the mother before pregnancy, the height of the mother before pregnancy, whether the mother is breastfeeding the infant or not, the birth weight of the infant or young child, the height of the infant or young child at birth, or the gender of the infant or young child. Other information not known to be related to the risk of obesity, immediate and/or later in life, for an infant or young child at the time of this application but later discovered to be such a sub-factor can be requested and/or entered in step 103, and the present disclosure is not limited to these examples of the information.

In Step 105, the interactive tool can obtain information related to the risk of allergy, immediate and/or later in life, for an infant or young child. Preferably the interactive tool obtains the information on at least one screen that is different from the one or more screens that obtain the information related to the risk of obesity. Preferably the user of the device manually enters the information into the interactive tool using the device.

In an embodiment, the interactive tool provides data fields in the user interface of the device requesting the information. The information can be, for example, whether the infant or young child is/was exclusively breastfed for the first 6 months after birth; whether one of the parents has an allergy history; whether any direct relatives have an allergy history; if the family lives in a polluted city; whether the infant or young child lives in an environment with second-hand smoke or was the mother exposed to tobacco smoke during pregnancy; and any combinations thereof. Other information not known to be related to the risk of allergy, immediate and/or later in life, for an infant or young child at the time of this application but later discovered to be such a sub-factor can be requested and/or entered in Step 105, and the present disclosure is not limited to these examples of the information.

In Step 107, the interactive tool can obtain information related to the immediate risk of an underdeveloped immune system and/or the risk of an underdeveloped immune system later in life for an infant or young child. Preferably the interactive tool obtains the information related to the risk of an underdeveloped immune system on at least one screen that is different from the one or more screens that obtain the information related to the risk of obesity and the one or more screens that obtain the information related to the risk of allergy. Preferably the user of the device manually enters the information into the interactive tool using the device.

In an embodiment, the interactive tool provides data fields in the user interface of the device requesting the information. The information can be, for example, whether the infant or young child is/was exclusively breastfed for the first 6 months after birth, whether the infant or young child suffers from recurrent ear infections, whether the infant or young child regularly catches colds, whether the infant or young child has been diagnosed with asthma or allergies, whether the infant or young child lives in an environment with second hand smoke, and any combinations thereof. Other information not known to be related to the risk of an underdeveloped immune system, immediate and/or later in life, for an infant or young child at the time of this application but later discovered to be such a sub-factor can be requested and/or entered in Step 107, and the present disclosure is not limited to these examples of the information.

In Step 109, the interactive tool can obtain information related to the immediate risk of a not well-functioning digestive system (e.g. not a smooth digestion) of an infant or young child. Preferably the interactive tool obtains the information related to the immediate risk of a not well-functioning digestive system on at least one screen that is different from the one or more screens that obtain the information related to the risk of obesity, the one or more screens that obtain the information related to the risk of allergy, and the one or more screens that obtain the information related to the risk of an underdeveloped immune system. Preferably the user of the device manually enters the information into the interactive tool using the device.

In an embodiment, the interactive tool provides data fields in the user interface of the device requesting the information. The information can be, for example, whether the infant or young child ever has unusually runny stools, whether the infant or young child ever had colic, whether the infant or young child has difficulty passing stools and/or has very hard stools, whether the infant or young child regularly spits up their feed, and any combinations thereof. Other information not known to be related to the immediate risk of a not well-functioning digestive system for an infant or young child at the time of this application but later discovered to be such a sub-factor can be requested and/or entered in Step 109, and the present disclosure is not limited to these examples of the information.

In Step 111, the interactive tool can perform an analysis of the information in the profile to evaluate the risk of obesity, immediate and/or later in life; the risk of an allergy, immediate and/or later in life; the risk of an underdeveloped immune system, immediate and/or later in life; and an immediate risk of a not well-functioning digestive system (e.g. not a smooth digestion) for the infant or young child. For example, the analysis of whether the young child has an immediate risk of obesity and/or a risk of obesity later in life can be based at least partially on comparison of the BMI of the mother before pregnancy to a threshold, such as 25 kg/m² for example; comparison of the birth weight of the infant to a threshold, such as 4 kg for example; and determination if the mother is/was exclusively breastfeeding the infant or young child for the first 6 months after birth or not.

In Step 113, the user interface of the device providing the interactive tool can provide results of the evaluation of the information, such as whether a risk of obesity, immediate and/or later in life; a risk of an allergy, immediate and/or later in life; a risk of an underdeveloped immune system, immediate and/or later in life; and/or an immediate risk of a not well-functioning digestive system (e.g. not a smooth digestion) are present; a numeric value for one or more of these risk factors, such as an estimated probability expressed as a percentage; how many sub-factors were fulfilled that suggest the corresponding risk factor; and/or the like. The user interface can suggest visiting a healthcare professional.

The interactive tool can create a profile for the user, and the profile can comprise the information related to the risk factors for later in life for the infant or young child. The device providing the interactive tool can store at least a portion of the profile. Alternatively or additionally, a remotely located database can store at least a portion of the profile. In an embodiment, the remotely located database is connected to the device by a wireless network, such as the internet. The interactive tool can create a profile automatically or in response to user input on the device providing the interactive tool. In an embodiment, the interactive tool can be executed without creating a profile for the user and/or without storing the information entered by the user.

In an embodiment, the interactive tool can obtain additional information subsequent to when the information is obtained in Steps 103-109. For example, the additional information can comprise a weight value and a length value of the infant or young child at a specific age of the infant or young child, and the weight value and the length value of the infant or young child at the specific age can be obtained by the interactive tool proximate to when the infant or young child reached the specific age. Preferably the user of the device manually enters the additional information into the interactive tool using the device.

The interactive tool can update the profile of the infant or young child to include the additional information. In an embodiment, the interactive tool generates or adjusts a growth curve of the infant or young child based on the additional information. Then the updated profile and the information in the profile can be used to evaluate the risk factors for the infant or young child again. The interactive tool can update the profile and evaluate the risk factors for the infant or young child each time additional information, such as new weight and length values of the infant or young child, is entered. However, as noted above, some embodiments of the interactive tool can be executed without creating a profile for the user and/or without storing the information entered by the user.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
accepting user input into an interactive tool provided by a device comprising a processor, the user input comprising information regarding health characteristics of an infant or young child;
performing an analysis of the information provided by the user input, and the analysis is performed by the device providing the interactive tool; and
displaying on the device an indication of whether the infant or young child has a health risk or does not have the health risk, the indication is based at least partially on the analysis of the information by the device, and the health risk is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof.

2. The method of claim 1 wherein the health risk is selected from the group consisting of (i) an immediate risk of an allergy for the infant or young child, (ii) a risk of an allergy later in life for the infant or young child, (iii) an immediate risk of an underdeveloped immune system for the infant or young child, (iv) a risk of an underdeveloped immune system later in life for the infant or young child, (v) an immediate risk of a not well-functioning digestive system for the infant or young child and (vi) any combinations thereof.

3. The method of claim 1 comprising displaying a message on the device, and the message is based at least partially on the analysis of the information by the device and suggests a visit to a healthcare professional.

4. The method of claim 3 wherein the healthcare professional will recommend one or more types of nutritional compositions.

5. The method of claim 4 wherein the one or more types of nutritional compositions are one or more types of infant formula or growing up milk.

6. The method of claim 1 wherein the information accepted by the device comprises a first portion related to growth of the infant or young child, a second portion related to allergy characteristics of the infant or young child, a third portion related to immunity characteristics of the infant or young child, and a fourth portion related to digestive characteristics of the infant or young child.

7. The method of claim 6 wherein the first, second, third and fourth portions are accepted by the device sequentially relative to each other.

8. The method of claim 1 wherein the indication displayed by the device identifies how many of the health risks are applicable to the infant or young child.

9. The method of claim 1 wherein the analysis additionally comprises determining a presence or absence of an immediate risk of obesity for the infant or young child and/or a risk of obesity later in life for the infant or young child, and the presence or absence is at least partially based on a criterion selected from the group consisting of (i) whether the infant or young child is or was exclusively breastfed for the first six months after birth, (ii) a threshold pre-pregnancy body mass index (BMI) of the mother of the infant or young child, (iii) a threshold weight of the infant at birth, (iv) weight gain of the infant or young child since birth and (v) any combinations thereof.

10. The method of claim 1 wherein the analysis comprises determining a presence or absence of an immediate risk of an allergy for the infant or young child and/or a risk of an allergy later in life for the infant or young child, and the presence or absence is at least partially based on a criterion selected from the group consisting of (i) whether the infant or young child is/was exclusively breastfed for the first 6 months after birth; (ii) whether one of the parents has an allergy history; (iii) whether any direct relatives have an allergy history; (iv) if the family lives in a polluted city; (v) whether the infant or young child lives in an environment with second-hand smoke or was the mother exposed to tobacco smoke during pregnancy; and (vi) any combinations thereof.

11. The method of claim 1 wherein the analysis comprises determining a presence or absence of an immediate risk of an underdeveloped immune system for the infant or young child and/or a risk of an underdeveloped immune system later in life for the infant or young child, and the presence or absence is at least partially based on a criterion selected from the group consisting of (i) whether the infant or young child is/was exclusively breastfed for the first 6 months after birth, (ii) whether the infant or young child suffers from recurrent ear infections, (iii) whether the infant or young child regularly catches colds, (iv) whether the infant or young child has been diagnosed with asthma or allergies, (v) whether the infant or young child lives in an environment with second hand smoke, and (vi) any combinations thereof.

12. The method of claim 1 wherein the analysis comprises determining a presence or absence of an immediate risk of a not well-functioning digestive system for the infant or young child, and the presence or absence is at least partially based on a criterion selected from the group consisting of (i) whether the infant or young child ever has unusually runny stools, (ii) whether the infant or young child ever had colic, and (iii) any combinations thereof.

13. A device comprising a processor and configured to display data fields for entry of information related to a health risk selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof, and the processor is configured to evaluate a presence or absence of the health risk for the infant or young child based at least partially on the information.

14. The device of claim 13 wherein the health risk is selected from the group consisting of (i) an immediate risk of an allergy for the infant or young child, (ii) a risk of an allergy later in life for the infant or young child, (iii) an immediate risk of an underdeveloped immune system for the infant or young child, (iv) a risk of an underdeveloped immune system later in life for the infant or young child, (v) an immediate risk of a not well-functioning digestive system for the infant or young child and (vi) any combinations thereof.

15. The device of claim 13 wherein the device is configured to additionally display data fields for entry of information related to an immediate risk of obesity and/or a risk of obesity later in life.

16. The device of claim 13 wherein the device is selected from the group consisting of a tablet, a smartphone, a desktop computer, a laptop computer, and a personal digital assistant.

17. The device of claim 13 wherein the device comprises a component selected from the group consisting of:
(i) means for determining whether or not the infant or young child has an immediate risk of an allergy,
(ii) means for determining whether or not the infant or young child has a risk of an allergy later in life,
(iii) means for determining whether or not the infant or young child has an immediate risk of an underdeveloped immune system,
(iv) means for determining whether or not the infant or young child has a risk of an underdeveloped immune system later in life,
(v) means for determining whether or not the infant or young child has an immediate risk of a not well-functioning digestive system, and
(vi) any combinations thereof.

18. The device of claim 17 wherein the device additionally comprises means for determining whether or not the infant or young child has an immediate risk of obesity and/or means for determining whether or not the infant or young child has a risk of obesity later in life.

19. A system comprising a database connected to a remotely located device comprising a processor providing an interactive tool that evaluates a health risk for an infant or young child, the health risk is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof, and the database updates the interactive tool with a factor for the health risk.

20. The system of claim 19 wherein the health risk is selected from the group consisting of (i) an immediate risk of an allergy for the infant or young child, (ii) a risk of an allergy later in life for the infant or young child, (iii) an immediate risk of an underdeveloped immune system for the infant or young child, (iv) a risk of an underdeveloped immune system later in life for the infant or young child, (v) an immediate risk of a not well-functioning digestive system for the infant or young child and (vi) any combinations thereof.

21. The system according to claim 19 wherein the interactive tool additionally evaluates an immediate risk of obesity and/or a risk of obesity later in life.

22. The system of claim 19 wherein the device is configured to accept user input providing information relating to the health risk for a specific infant or young child, and the database stores at least a portion of the information.

23. A method comprising:
accepting user input into an interactive tool provided by a device comprising a processor, the user input comprising information related to one or more health risks for an infant or young child, each of the one or more health risks is selected from the group consisting of (i) a risk of an allergy for the infant or young child, (ii) a risk of an underdeveloped immune system for the infant or young child, (iii) a risk of a not well-functioning digestive system for the infant or young child and (iv) any combinations thereof; and
displaying on the device a message based at least partially on the health risks that are applicable to the young child or infant, and the message suggests a visit to a healthcare professional.

24. The method of claim 23 wherein the health risk is selected from the group consisting of (i) an immediate risk of an allergy for the infant or young child, (ii) a risk of an allergy later in life for the infant or young child, (iii) an immediate risk of an underdeveloped immune system for the infant or young child, (iv) a risk of an underdeveloped immune system later in life for the infant or young child, (v) an immediate risk of a not well-functioning digestive system for the infant or young child and (vi) any combinations thereof.

25. The method according to claim 23 wherein the user input additionally comprises information related to an immediate risk of obesity and/or a risk of obesity later in life.
